(19) United States
(12) Patent Application Publication
(10) Pub. No.: US 2005/0151092 A1
(43) Pub. Date: Jul. 14, 2005

(54) Manipulator apparatus, manipulating system, image processing apparatus, program, and apparatus controlling process

(75) Inventor: Hideya Kitagawa, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, TOKYO (JP)

(21) Appl. No.: 10/963,136

(22) Filed: Oct. 12, 2004

(30) Foreign Application Priority Data
Oct. 14, 2003 (JP) 2003-354015

(51) Int. Cl. G21K 5/10

(52) U.S. Cl. 250/442.11

(57) ABSTRACT

A manipulator apparatus equipped with a manipulating implement which manipulates a cell, and a holding part holding the manipulating implement and a presuming device, in which an image including the holding part was read to obtain the location of the tip of the manipulating implement to the holding part from the image information of the holding part.

### BACKGROUND OF THE INVENTION

1. Field of the Invention

The present invention relates to a manipulator apparatus, a manipulating system, an image processing apparatus, a program, and an apparatus controlling process.

Priority is claimed on Japanese Patent Application No. 2003-354015, filed Oct. 14, 2003, the content of which is incorporated herein by reference.

2. Description of Related Art

Heretofore, when injecting a substance or the like selectively into a minute sample like a cell, a manipulator which holds manipulating implements, such as a needle and a pipette, is positioned in three dimensions relative to the sample which is a target, within the view of a microscope, and then treatments are performed. At this time, it is generally necessary to operate the manipulator, while grasping the relative spatial relationship between the manipulating implement and the sample or the container by the blurring degree of the focus by observation or the like, and such a manipulation requires skill.

For example, in the invention disclosed in the Japanese Unexamined Patent Application, First Publication No. H06-109979, in order to improve the operativity of these operations, the manipulating implement was directly contacted to the container bottom, and the contact situation is detected by microscope. That is, checking coincidence of the focus at the manipulating implement and the bottom of the container, or bending modification of the manipulating implement, such that the height of the manipulating implement at this time is registered as the standard height. Then the height relation among the sample, the manipulating implement, and the bottom of the container is controlled, based on the sample size and the amount of movements of the height direction of the manipulating implement which can be predicted.

The above invention displays these height relations schematically, such that an operator grasps the 3-dimensional spatial relationship, thereby improving operativity. In the other examples, the standard height is detected by reading the height relation among the sample, the manipulating implement, and the bottom of a container through the distance between the focuses of a microscope, without contacting the manipulating implement and the container bottom, alternatively by contacting the manipulating implement with the sample.

In the case in which a substance or the like is injected into the sample having low tolerance, such as a live cell (size in about 10 to 20 micrometers), it is necessary for the manipulating implement inserted into the sample to have a tip being sharp and thin as far as possible, in order to stop invasion.

### SUMMARY OF THE INVENTION

That is, a manipulator apparatus concerning the first aspect of the present invention includes: a manipulating device for manipulating a manipulated object, a holding device for holding the manipulating device having a size which can be detected by photography, a picture acquiring device for acquiring an image including the holding device, and a presuming device for presuming a position of the tip of the manipulating device, based on the image.

It should be noted that the picture acquiring device includes both one which is disposed at the manipulator itself and acquires a picture by photographing for oneself, and one which captures pictures photographed by any of the other devices which are not contained in the manipulator itself.

A manipulating system concerning the second aspect of the present invention is one which includes the manipulator apparatus of the first aspect of the present invention.

An image processing apparatus concerning the third aspect of the present invention is one which is used for an apparatus including a manipulating device for manipulating a manipulated object, a holding device for holding the manipulating device having a size which can be detected by photography, a picture acquiring device for acquiring an image including the holding device, wherein a location of a tip of the manipulating device is assumed based on the image.

A program concerning the fourth aspect of the present invention is one for the use of a control device for controlling an apparatus, including: a manipulating device for manipulating a manipulated object; a holding device for holding the manipulating device having a size which can be detected by photography; a picture acquiring device for acquiring an image including the holding device; and a presuming device for presuming a position of the tip of the manipulating device, based on the image, wherein the control device is made to control such that the presuming device performs the presuming based on the image.

A process for controlling an apparatus concerning the fifth aspect of the present invention is one for controlling an apparatus which is equipped with a manipulating device for manipulating a manipulated object, and a holding device for holding the manipulating device having a size which can be detected by photography, including: photographing an image including the holding device, and presuming a location of the tip of the manipulating device based on the image acquired by the photographing.

### BRIEF DESCRIPTION OF THE DRAWINGS

FIG. 1 is a figure showing the first embodiment of the manipulator apparatus of the present invention, and is a schematic view explaining an apparatus constitution.

FIG. 2 is a perspective view showing the appearance of the manipulator apparatus.

FIGS. 3A to 3C are figures showing the shape of the holding part disposed to the manipulator apparatus, and FIG. 3A is a left-hand side view, FIG. 3B is a front view, and FIG. 3C is a bottom view.

FIGS. 4A to 4D are figures explaining the process which performs image processing to the image of the holding part of the manipulator apparatus to obtain the location of the tip of a manipulating implement. FIGS. 4A and 4C are the images photographed from the front, and FIGS. 4B and 4D are the images photographed from the bottom.

FIGS. 5A and 5B are figures explaining the method of recognizing the relative spatial relationship between the location of the tip of the manipulating implement held at the holding part of the manipulator apparatus, and a cell or the container bottom. FIG. 5A is the image which is looked at from the bottom, and FIG. 5B is the image which is looked at from the front.

FIG. 6 is a flow chart for explaining the flow of injection operation using the manipulator apparatus.

FIG. 7 is a figure showing the second embodiment of the manipulator apparatus of the present invention, and is a schematic view explaining apparatus constitution.

FIGS. 8A and 8B are figures explaining the method of recognizing the relative spatial relationship between the location of the tip position of the manipulating implement held at the holding part of the manipulator apparatus, and a cell or the container bottom. FIG. 8A is the image which is looked at from the bottom, and FIG. 8B is the image which is looked at from the front.

FIG. 9 is a figure showing the third embodiment of the manipulator apparatus of the present invention, and is a schematic view explaining apparatus constitution.

FIGS. 10A to 10C are figures showing the shape of the holding part which is disposed to the manipulator apparatus. FIG. 10A is a left-hand side view, FIG. 10B is a front view, and FIG. 10C is a bottom view.

FIGS. 11A and 11B are figures explaining the process which performs image processing to the image of the holding part of the manipulator apparatus to obtain the location of the tip of the manipulating implement. FIG. 11A is the image photographed from the front, and FIG. 11B is the image photographed from bottom.

FIG. 12 is a figure showing the fourth embodiment of the manipulator apparatus of the present invention, and is a front view of the holding part and of the operation axis holding this.

FIGS. 13A to 13C are figures showing the shape of the holding part which is disposed to the manipulator apparatus. FIG. 13A is a left-hand side view, FIG. 13B is a front view, and FIG. 13C is a bottom view.

FIGS. 14A and 14B are figures explaining the process which performs image processing to the picture of the holding part of the manipulator apparatus to obtain the location of the tip of the manipulating implement. FIG. 14A is the image photographed from the left-hand side, and FIG. 14B is the image photographed from the bottom.

FIG. 15 is a figure showing the fifth embodiment of the manipulator apparatus of the present invention, and is a schematic view explaining apparatus constitution.

FIGS. 16A to 16C are figures showing the container which is disposed to the manipulator apparatus. FIG. 16 is a plan view, FIG. 16B is the A-A sectional view of FIG. 16A, and FIG. 16C is a view looked at from the bottom opposite.

FIG. 17 is a longitudinal cross-section for explaining the photographing method using the container.

FIGS. 18A and 18B are figures explaining the sixth embodiment of the manipulator apparatus of the present invention. FIG. 18A is a front view for explaining contact motion of the manipulating implement to a cell, and FIG. 18B is the observation picture which was plane-viewed the cell before and after the manipulating implement comes into contact.

FIG. 19 is a plan view explaining the method of detecting the modification of the cell through an image processing.

FIGS. 20A to 20C are figures explaining the seventh embodiment of the manipulator apparatus of the present invention. FIG. 20A is a plan view showing a cell before and after amanipulating implement comes into contact with the cell. FIG. 20B is a plan view showing the state where it is divided virtually using a square to the image of the cell before the contact, and FIG. 20C is a plan view showing the state where it is divided virtually using a square to the image of the cell after the contact.

FIGS. 21A to 21C are figures explaining the eighth embodiment of the manipulator apparatus of the present invention. FIG. 21A is a plan view showing a cell before and after the manipulating implement comes into contact with the cell, and FIG. 21B is a plan view showing the state where image processing is performed to the picture of the cell before the contact, and FIG. 21C is a plan view showing the state where image processing is performed on the picture of the cell after the contact.

FIG. 22 is a figure explaining the ninth embodiment of the manipulator apparatus of the present invention, and is a longitudinal cross section showing the inside of the container.

FIG. 23 is a figure showing contact operation to the simulated living organism sample in the manipulator apparatus, the upper figure is a front view before contact, whereas the lower figure is a front view after contact.

FIG. 24 is a figure showing contact operation to the simulated living organism sample in the manipulator apparatus, the upper figure is a plan view before contact, whereas the following figure is a plan view after contact.

FIG. 25 is a figure explaining the tenth embodiment of the manipulator apparatus of the present invention, and is a perspective view showing the cell in a container.

FIG. 26 is a front view for explaining obtaining a virtual average plane based on the virtual plane formed of the upper end of the cell in a container.

FIG. 27A and FIG. 27B are figures showing the modification of holding part shape, FIG. 27A is a front view, whereas FIG. 27B is a figure showing the bottom looked from a visual line which is opposed to the bottom.

FIGS. 28A and 28B are figures showing other modifications of the holding part, and FIG. 28A is a front view, whereas FIG. 27B is a figure showing the bottom looked at from a visual line which is opposed to the bottom.

### DETAILED DESCRIPTION OF THE INVENTION

Preferred embodiments of a manipulator apparatus of the present invention, a manipulating system, an image processing apparatus, a program, and a controlling method of an apparatus will be explained below, respectively, referring to drawings. However, of course, the present invention is not limited only to these embodiments.

### First Embodiment

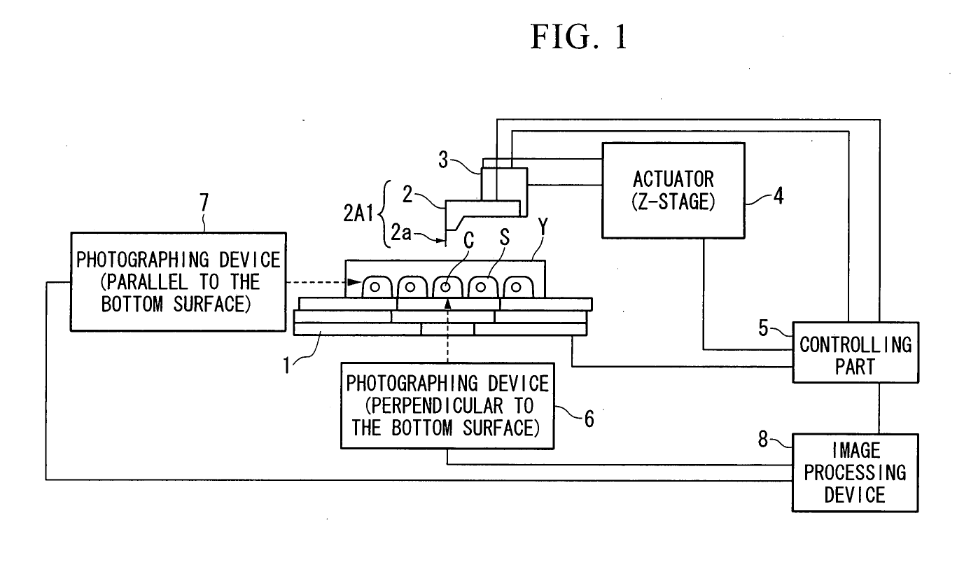

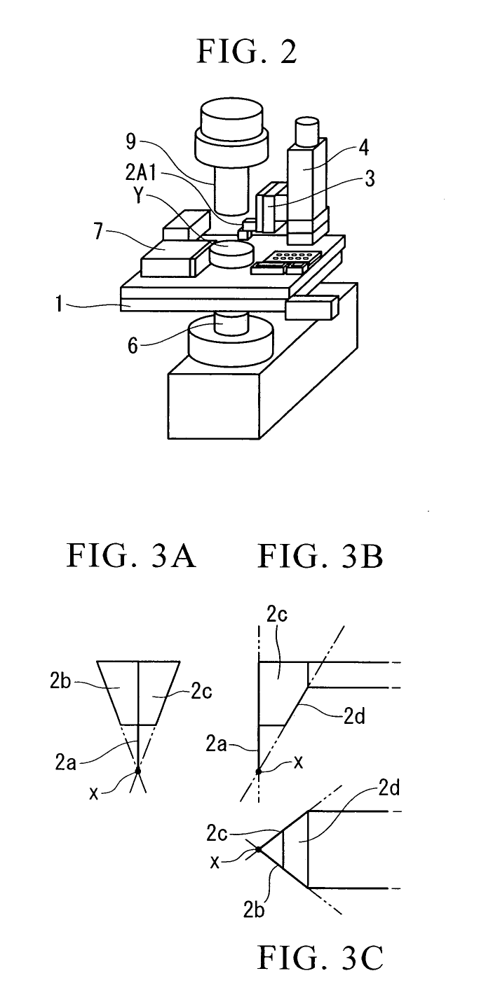

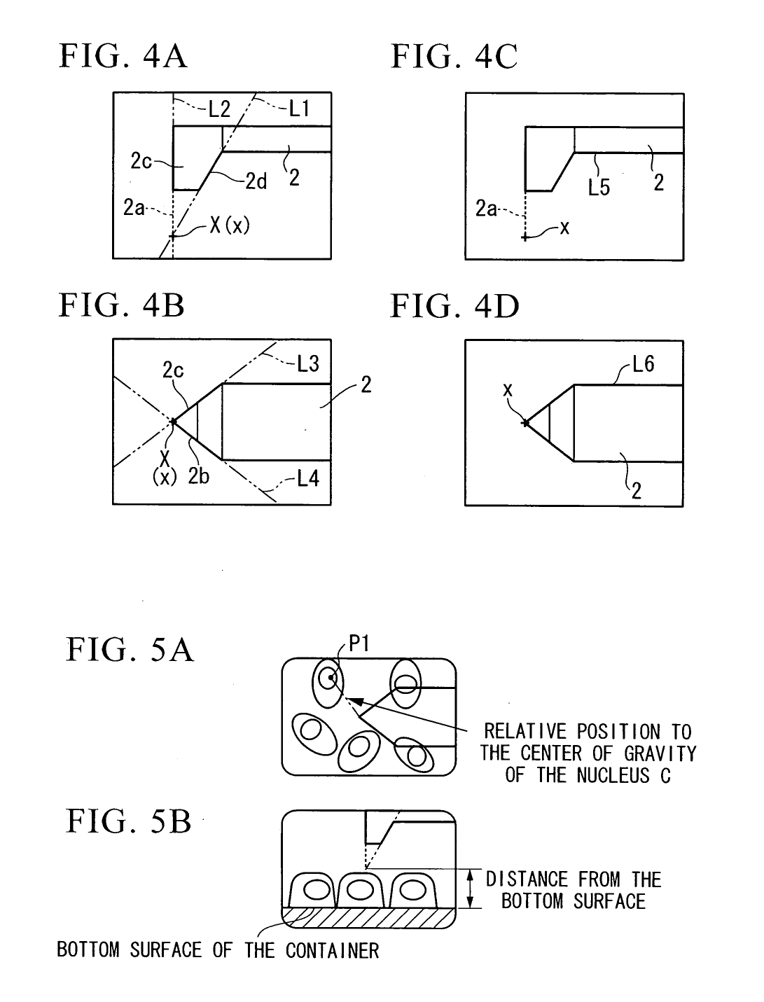

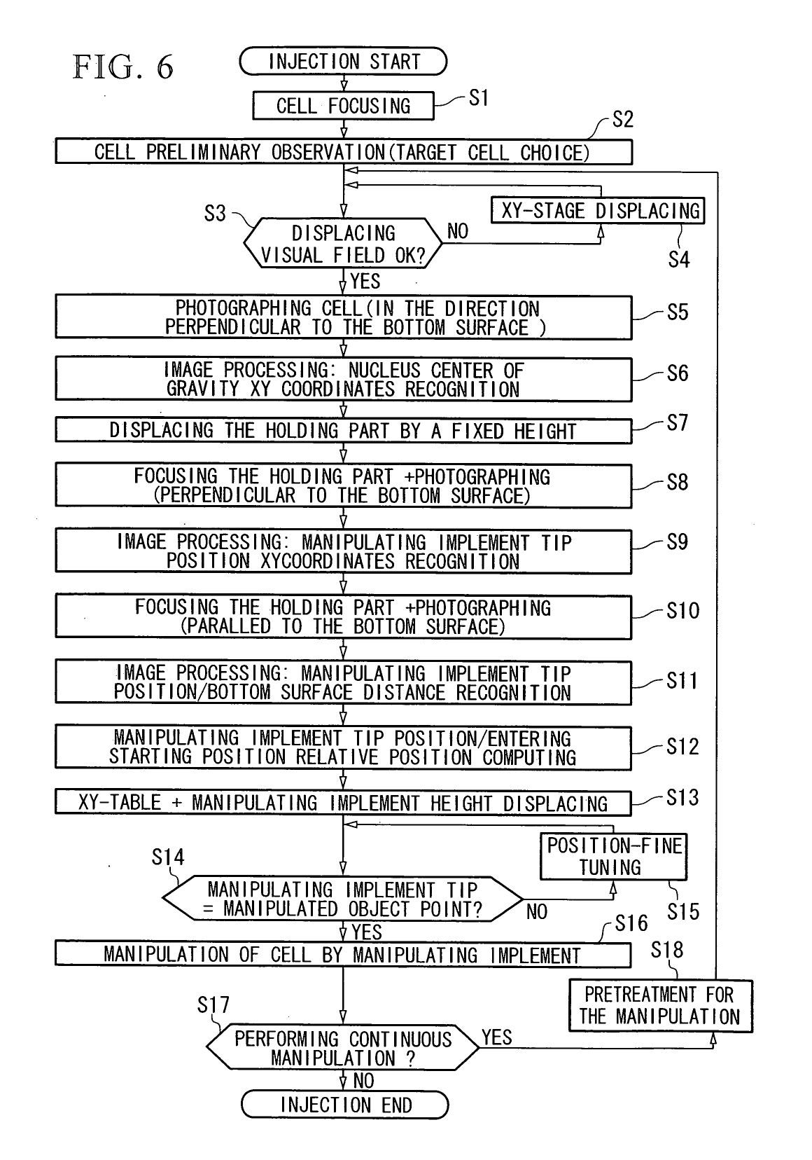

First, the first embodiment will be explained, referring to FIGS. 1 to 6. It should be noted that FIG. 1 is a schematic view showing a system constitution. Moreover, FIG. 2 is a perspective view showing apparatus appearance. In addition, FIGS. 3A to 3C are figures showing the shape of a holding part, FIG. 3A shows a left-hand side view, FIG. 3B shows a front view, and FIG. 3C shows the bottom plan view. Moreover, FIGS. 4A to 4D are figures which explain how to recognize the tip location of a manipulating implement, from the reference shape by image processing, and FIGS. 4A and 4C are front views, whereas FIGS. 4B and 4D are bottom plan views. Moreover, FIGS. 5A and 5B are figures explaining how to recognize the spatial relationship between the manipulating implement tip and the cell in an observing picture. Moreover, FIG. 6 is a flow chart for explaining an injection operation by the manipulator apparatus.

The manipulator apparatus of this embodiment is one which makes an extra fine needle-like manipulating implement come into contact with a core of a cell or insert an extra fine needle-like manipulating implement into a core of a cell to inject a substance, one which gives stimulus by electricity or vibration to a cell, or one which performs extracting of organs or substances in a cell. The manipulator apparatus of this embodiment constitutes a part of a manipulating system (not shown in the drawings) which performs an operation, an observation, and a recording, in the block.

In addition, although it is not shown in the drawings, this manipulating system is equipped with a manipulator apparatus, a monitor which displays the variety of information transmitted from the manipulator apparatus, a computer which controls the manipulator apparatus from the outside, and an exchanging device for exchanging the manipulator of the manipulator apparatus. It should be noted that the monitor may be disposed with the manipulator apparatus itself.

The manipulator apparatus has a size smaller than a photography resolution limit, and which is equipped with a manipulating implement (manipulating device) which operates a cell (manipulated object), a holding part (holding device) which holds the manipulating implement and has a size which can be detected by photography (larger than a photography resolution limit), a photographing device which constitutes a part of picture acquiring device for acquiring an image including this holding part and a cell, and an image-processing device (presuming device) to determine the location of the tip of the manipulating implement based on the image. It should be noted that the image may be acquired by photographing through the photographing device which is disposed to the manipulator apparatus itself, alternatively, it is also possible that an image photographed by any other device which is not disposed to the manipulator apparatus itself is captured by the picture acquiring device.

The image-processing device can determine the location of the tip of the manipulating implement, based on the image information recognized from the image. It should be noted that the “image information” referred to in the present invention indicates the reference standard for obtaining the location of the tip of the manipulating implement in three dimensions, based on the image (visual image) of the holding part which is projected, such as outer shape of the holding part, and a sign such as a bar code attached to the holding part.

As to the above, it will be explained concretely, with reference to the drawings. As shown in FIGS. 1 and 2, the manipulator apparatus is equipped with an XY stage 1 on which a container Y is laid; a manipulator 2A1 disposed to an upper portion above the XY stage 1; an operating axis 3 which holds the manipulator 2A1; a Z stage 4 which holds the operating axis 3; a controlling part 5 which controls these XY stage 1, the operating axis 3, and the Z stage 4; photographing devices 6 and 7 which photographs the living organism sample in the container Y (cell S) from two directions; an image-processing device 8 which captures and performs an image processing of the image photographed through the photographing devices 6 and 7, and a lighting device 9 (which is omitted in FIG. 1) to supply light in the container Y It should be noted that the manipulator 2A1 is equipped with the holding part 2 held by the operating axis 3, and the manipulating implement 2a held by the holding part 2. Moreover, on the monitor, the information (this information is generated by the image-processing device 8 which serves as an information generating device.) concerning the holding part 2, the cell S, and the location of the tip of the manipulating implement 2a determined by the method mentioned later, etc., are displayed.

The manipulator apparatus is constituted, such that while positioning the location of the container Y which contains the cell S on the XY stage 1, positioning of the location of the manipulator 2A1 can be performed by each actuator which is disposed to the Z stage 4. In moving the manipulator 2A1 in an insertion direction (i.e. the direction parallel to the Z-axis which is perpendicular to the loading surface of the XY stage 1 and to the lower right), it is driven by the operation axis 3. In each actuator, such as the actuators which drive the XY stage 1, the actuator which drives the Z stage 4, and the actuator which drives the operating axis 3, a pulse motor or a piezo motor is employed as a driving source, respectively, a linear guide, etc., is employed to secure an advancing accuracy, and the amount of movements and speed is controlled by a pulse management, for example.

The container Y has an opening at the upper part thereof, and side walls and bottom which are made of transparent members which are suitable for optical observation. Each cell S which is accommodated in the container Y is adhered to the bottom surface of the container Y and is held there immersed in the culture solution held in the container Y.

The relative spatial relationship between the location of the tip x of the manipulating implements 2a such as a needle held by the holding part 2 which constitutes the manipulator 2A1, and the location of the center of gravity of the nucleus C of the cell S can be obtained on the XY plane (a plane parallel to the loading surface of the XY stage 1) by the photographing device 6 having a photographing direction of the rectangular direction to the bottom surface of the container Y, and the image-processing device 8.

The photographing device 6 is a camera in which the lens which is not shown in the drawings is combined with a CCD (optical image sensor), and which can open up both the holding part 2 and the cell S in the observation area in a field. It should be noted that the photographing device 6 and the image-processing device 8 can also obtain the spatial relationship of the predetermined point corresponding to the purposes, such as a center position of organelles in a cell, such as the endoplasmic reticulum and a Golgi body, and a position which avoids them, for example, besides obtaining the location of the center of gravity of the nucleus C of the cell S. Moreover, the controlling part 5 may control the image processing device 8 at this time.

The other photographing device 7 having a photographing direction parallel to the bottom surface of the container Y can obtain the relative location relationship between the location of the lowest end (tip) of the manipulating implement (needle) 2a in a height direction, and the location of the bottom surface of the container Y in a height direction near the cell S by a combination with the image processing device 8.

The contact height or insertion starting height of the manipulating implement 2a is obtained as a height dimension from the bottom surface of the container Y, based on the prediction size of the cell S. It should be noted that, in addition to this, it is also possible to obtain the contact height of the manipulating implement 2a, the insertion starting height, and further, the insertion depth from the change of the photographed image by the photographing device 7 when the manipulating implement 2a comes into contact with the cell S.

Similar to the photographing device 6, the photographing device 7 is a camera in which the lens which is not illustrated is combined with a CCD (optical image sensor), and which can open up both the holding part 2 and the cell S in the observation area in a field. It should be noted that the photographing device 7 and the image-processing device 8 can also obtain the spatial relationship of the predetermined point corresponding to the purposes, such as a center position of organelles in a cell, such as an endoplasmic reticulum and a Golgi body, and a position which avoids them, for example, besides obtaining the location of the center of gravity of the nucleus C of the cell S. Moreover, the controlling part 5 may control the image processing device 8 at this time.

The controlling part 5 controls each of the actuators in a three-dimensional way, such that the relative location between the manipulating implement 2a and the cell S should be matched, based on the spatial relationship of the contact or the insertion starting point of the manipulating implement 2a and the cell S recognized on the image-processing device 8, and that the manipulating implement 2a should be in contact with or be inserted into the cell S up to the nucleus C, thereby performing operations such as injection of a solution or application of stimulus by adding an electrical voltage.

As shown in FIGS. 3A to 3C, a plurality of base levels (image information) 2b, 2c, and 2d used as the reference standard at the time of obtaining the location of the tip of the manipulating implement 2a are formed in the holding part 2. As shown in FIG. 3C, when the holding part 2 is looked at from the bottom, the base levels 2b and 2c are designed and manufactured such that the needlelike manipulating implement 2a may cross mutually at a point. More in detail, the ridgeline where two base levels 2b and 2c which are both perpendicular planes cross mutually, and the axis line of the manipulating implement 2a will make the same axis. Therefore, the location of the tip x of the manipulating implement 2a on the XY plane can be obtained by simply looking up the holding part 2 to find the crossing of the base levels 2b and 2c.

Similarly, as shown in FIG. 3B, the base level 2d forms a straight line, when the holding part 2 is looked at from the front, and the base level 2d is designed and manufactured, such that the point on which the extended line of the straight line intersects the extended line of the above ridgeline matches the location of the tip x of the manipulating implement 2a. Therefore, the location of the tip x of the manipulating implement 2a in the Z-axis direction can be obtained by simply looking at the holding part 2 from the front to find the crossing of the extended line of the base level 2d and the extended line of the above ridgeline.

As explained in the above, it becomes possible to determine the location of the tip x of the manipulating implement 2a in three dimension by making the base levels 2b, 2c, and 2d, which make the outside of the holding part 2, be a reference standard.

As will be explained below more in detail, as to a method for recognizing the location of the tip x of the manipulating implement 2a by performing an image processing of the image of the holding part 2, at the image-processing device 8. It should be noted that, as this method, the recognizing method (2) mentioned below can be adapted, in addition to the following recognition method (1).

(1) First Recognizing Method

As shown in FIG. 4A, the image which is looked at from the front of the holding part 2 is acquired to obtain the intersection X of the straight line L2 which is an extended line including the above ridgeline, and the straight line L1 which is an extended line including the straight line which is formed by the base level 2d, by image processing. Furthermore, as shown in FIG. 4B, the image which is one looked at from the bottom surface of the holding part 2 is acquired to obtain the intersection X of the straight line L3 which is an extended line of the straight line which is formed by the base level 2c, and the straight line L4 which is an extended line of the straight line which is formed by the base level 2b, by image processing. Thus, the intersection X obtained in three dimensions way can be recognized as the location of the tip x of the manipulating implement 2a.

(2) Second Recognizing Method

As shown in FIG. 4C, while storing beforehand the outline L5 (ridgeline) at the time of looking the holding part 2 from the side as a pattern shape, the location of the tip x of the manipulating implement 2a to the outline L5 is stored at the same time. Similarly, while storing beforehand the outline L6 (ridgeline) at the time of looking the holding part 2 from the bottom surface, which is shown in FIG. 4D, as a pattern shape, the location of the tip x of the manipulating implement 2a to the outline L6 is stored at the same time. And in performing a recognition, the image of the outline L5 and the outline L6 is acquired, and then the location of the tip x of the manipulating implement 2a is recognized based on the relative spatial relationship between the pattern shape of the holding part 2 stored beforehand and the location of the tip x.

When an error arises from insufficient manufacturing accuracy for the presumed accuracy of the location of the tip x as to the relative spatial relationship between the holding part 2 and the manipulating implement 2a, it is preferred to select the second recognizing method for obtaining the location of the tip x from these two recognizing methods, based on the test result after manufacturing.

Moreover, when it is required to select suitably and employ a plurality of holding parts 2, as shown in FIGS. 27A and 27B, which includes one which is different in shape and size from those shown in FIGS. 4A and 4B, it is also possible to store the table, etc., which correlates the reference standards and the pattern shapes of each holding parts 2 with the location of the tip x in the image processing device 8 beforehand, and then to access the pattern shape of the selected holding part 2 in performing a recognition, thereby obtaining the location of the tip x, based on the pattern shape.

However, this is the case in which the second recognizing method in the above is adopted, and when using the first recognizing method in the above, it is not necessary to store the pattern shape beforehand.

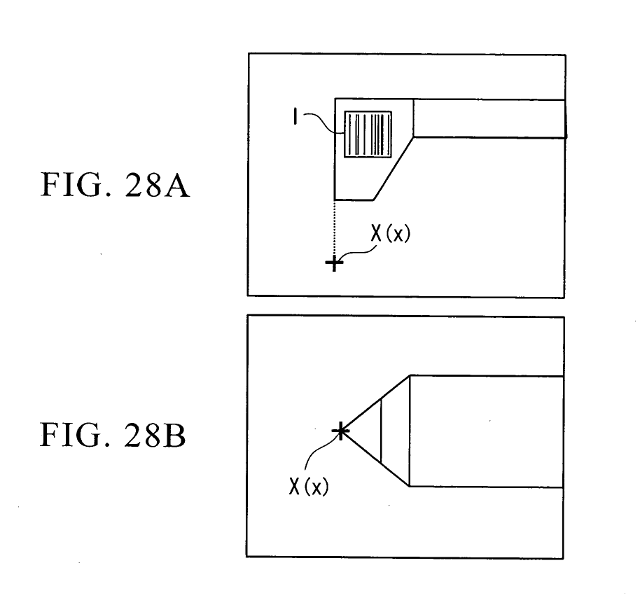

Furthermore, it is also possible to use the arrangement of geometrical shape as a reference information instead of the outline of the holding part 2. Concretely, as shown in FIGS. 28A and 28B, it will be easy to recognize the information (one which includes the information of the location of the tip x) of the holding part 2, by giving the information I, such as a bar code or a two dimensional code, to the holding part 2, and confirming and reading the information I.

It should be noted that in the stage of the above image processing, it enables the operator who operates the manipulator apparatus to check propriety of the operation easily by displaying typically the above straight lines L1 to L4, outlines L5 and L6, and the location of the tip x obtained therefrom on the screen which projects the images photographed by the above photographing devices 6 and 7.

As mentioned above, the controlling part (presuming device) 5 which obtains the location of the tip x of the manipulating implement 2a sets the point P1, which will be a standard in image processing, on a predetermined position (for example, the point on the upper surface of the cell S and right above the center of gravity of the nucleus C) on which the cell S which is recognized from the image presents, as shown in FIGS. 5A and 5B, and further, simultaneously, the controlling part 5 also serves as a spatial relationship presuming device which determines the relative spatial relationship between the location of the tip x of the manipulating implement 2a and the point P1, based on the image.

The concrete flow at the time of operating injection, etc., to the cell S will be explained below, with using the manipulator apparatus of this embodiment which has the constitution explained above and referring to FIG. 6.

First, in Step S1, the container Y which accommodated the cell S is set on the XY stage 1, and focusing the cell S is performed in the photographing device 6 having a microscope optical system, i.e., the photographing direction which intersects perpendicularly with the bottom surface of the container Y.

In the subsequential Step S2, a preliminary observation of the cell S is performed and the cell S which will be the manipulated object, such as injection, is selected. In the subsequential Steps S3 and S4, the XY stage 1 is moved by manual operation, and the field of view is adjusted such that the selected cell S comes to the position which is suitable for observation.

In the subsequential Step S5, the cell S is photographed by the above photographing device 6.

In the subsequential Step S6, the center of gravity position of the nucleus C is recognized as two dimensional coordinates in the image by performing image processing on the obtained image.

In the subsequential Step S7, the location of the manipulator 2A1 is moved down by the Z stage 4, and positioned to a predetermined height which is suitable for observation using the above photographing device 6.

In the subsequent Step S8, focusing the reference shape (outline, etc.,) of the holding part 2, and the holding part 2 is photographed by the above photographing device 6.

In the subsequent Step S9, the location of the tip x of the manipulating implement 2a is recognized as two dimensional coordinates in the image by performing image processing on the obtained image by the above method.

In the subsequent Step S10, by the horizontal photographing optical system 7 parallel to the bottom surface of the container Y, focusing the reference shape (outline, etc.) of the holding part 2 and the bottom surface of the container Y, within the same field of view, over the side wall surface of the container Y, is performed and photographed.

In the subsequent Step S11, the distance between the location of the tip x of the manipulating implement 2a, which is held by the holding part 2, and the bottom surface of the container Y is recognized by performing image processing on the obtained image.

In the subsequent Step S12, the spatial relationship in the XY direction between the location of the tip x of the manipulating implement 2a which is held at the holding part 2 and the nucleus C of the cell S, and the spatial relationship in the direction of Z-axis to the bottom surface of the container Y are computed. Furthermore, the relative position between the location of the tip x of the manipulating implement 2a and the upper end position (contact or insertion starting point) of the cell S of the nucleus C upper part is computed.

In the subsequent Steps S13 to S15, each actuator is controlled in three dimensions and the location of the tip x and the relative location of the insertion starting point is matched. When it is not matched, location fine tuning is repeated until it is matched.

In the Step S16 after the completion of positioning, the operating axis 3 is made to be in contact with or to be driven by a depth of insertion to make the manipulating implement 2a be in contact with or inserted into the cell S, thereafter operation such as injection or stimulating is performed. After this operation is completed, the operation axis 3 is evacuated and, finally the Z stage 4 is evacuated to a predetermined height.

In the subsequent Step S17, it is judged whether manipulations on the other cell S such as injection should be continuously performed or not, and when it is judged to perform it (Yes), it progresses to Step S18, and after performing a pretreatment required for operating the following cell S here, it progresses to the above step S3.

Whereas, when it is judged not to operate the next cell S continuously (No) in Step S17, the operation such as injection, etc., is completed.

As explained above, the manipulator apparatus of this embodiment has adopted the device which is equipped with the following constituents (a) to (f) as a way which solves the problem of the conventional technology.

(a) a container which can be optically observed in the state where a living organism sample was held in the bottom surface; the container referred to here is, for example, the container Y in the above, those of which internal condition can be observed from outside through the bottom surface or side wall thereof can be employable. It is not limited to those having the above mentioned shape, and containers having other shapes can be employed.

Moreover, the observed object accommodated in the inside of the container is not limited to living a sample of a organism (for example, the above cell S), and those which can be operated using a fine manipulating implement (for example, the above manipulating implement 2a) are employable, and those which accommodate the other manipulated object are also employable.

(b) A device having fine manipulating implements, a holding part which holds the manipulating implements has a shape which is observed in the direction of perpendicular or parallel to the bottom surface of the container, and a reference shape in which the relationship to the location of the tip is fixed: the manipulating implements indicates, for example, the above manipulating implement 2a, the holding part indicates, for example, the above holding part 2, and the device for performing manipulation indicates, for example, the above operating axis 3, respectively.

The manipulating implement manipulating implement is not limited to a needlelike one as in this embodiment, and one having at least a part of which the size is smaller than a photography resolution limit can be used, and further, one having the other shape may be used, if necessary.

Similarly, the holding part is not limited to one having the shape which was explained referring to the drawings, one of which shape and information (for example, a bar code, etc.) applied thereto can be confirmed from the image photographed is employable, and hence the holding part having the other arbitrary shape and size can be employed.

Similarly, the device for performing manipulation is not limited to the above operating axis 3 only, but it encompasses all constitutions which are required for manipulation such as injection or stimulating, for example, a driving mechanism which drives the holding part oncoming and departing direction, and a medical fluid supplying mechanism which supplies a medical fluid to an manipulated object by way of a manipulating implement.

(c) A photographing device which observes the holding part from a perpendicular direction or a parallel direction to the bottom surface of the container, to capture an image: to observe a holding part in a rectangular cross or a parallel direction on the bottom of a container, and to capture an image. The photographing device referred to here is, for example, the above photographing device 6 and the photographing device 7, and one which can photograph at least the image of the holding part, and the photographing method, the number, and the arrangement of which are not limited to those of one which was explained and shown in the above, respectively, and hence one having the other photographing method, the other number, and the other arrangement may be used.

Moreover, as the photographing device, one which can at least photograph the holding part within an image is employable, it is not always necessary to be able to photograph an image so that the manipulating implement is included in the image (that is, because it cannot be seen actually and precisely in a space part in which amanipulating implement is presumed to present is included in the image.).

(d) An image-processing device which processes the image captured to recognize the coordinates of the point which is specified from the shape in the image: The image-processing device referred to here is the above image-processing device 8, for example. It should be noted that, although in this embodiment it is explained as to an example in which the image-processing device 8 is independent from the controlling part 5, this is not restrictive, and it is also possible that the controlling part 5 has also the function of the image-processing device 8.

(e) Actuator which moves and positions the relative location between the manipulating implement tip and the living organism sample in three dimensions: The actuator referred to here is, for example, the above XY stage 1 and the Z stage 4, one which can adjust the relative location among the manipulating implement, the holding part, and the container, and the constitution which is explained and shown in the above is not restrictive, and hence the actuator mechanism having the other constitutions is employable.

For example, while moving the container side in up-and-down direction (the direction of Z-axis), the manipulating implement and/or the holding part side may be moved horizontally (the XY-axis direction). Furthermore, it is also possible to make both the container side and the manipulating implement and/or the holding part side movable in up-and-down direction (the direction of Z-axis) and horizontal direction (the XY-axis).

(f) A controlling device which performs a control of an operation to the living organism which includes moving the actuators, an exchanging of information with the image-processing device, and a controlling of the image-processing device: The controlling device referred to here is, for example, the above controlling device 5, it is possible to be disposed in the manipulator apparatus as in this embodiment, alternatively, it is also possible to make the other computer which is connected to the manipulator apparatus play this function.

The following actions are obtainable, because these constituents (a) to (f) are given.

That is, the holding part (the above holding part 2) is observed from two directions, one is a perpendicular direction and the other is a direction parallel to the bottom surface of the container (the above container Y) and photographed, by the photographing device (the above photographing devices 6 and 7).

The location of the tip of the manipulating implement (the above manipulating implement 2a) is virtually specified by the image-processing device (the above image-processing device), based on the reference shape to recognize the coordinates thereof.

The living organism sample (the above cell S) held in the container is observed from a perpendicular direction or a parallel direction by the photographing device to the bottom surface to be photographed.

The coordinate of the manipulated object of the living organism which is indicated on the screen is recognized by the image-processing device.

The relative spatial relationship between the coordinate of the location of the tip of the manipulating implement and the coordinate of the manipulated object point of the living organism is recognized by the controlling device (the above controlling part).

By the controlling device, the actuators (the above XY-stage 1 and the Z-stage 4) are controlled in a three dimensions, such that the tip of the manipulating implement comes close to the manipulated object point of the living organism, thereby enabling the manipulating implement to be in contact with or inserted into the living organism.

By the controlling device, the manipulating implement is in contact with or inserted into the living organism to operate an injection or stimulating.

By performing the above actions, the following effects will be obtainable.

That is, even if the manipulating implement (the above manipulating implement) is one which is extra fine, i.e., smaller than an optical resolving power, it is possible to recognize the location of the tip of the manipulating implement in the horizontal direction and in the height direction accurately, without fear of breaking by contact. Moreover, it is possible to performing operation such as injection of substances with a low invasion and a high efficiency, by controlling the relative location to the manipulated object point of the living organism (the above cell S) which is recognized similarly.

It should be noted that the method of controlling these operations may be performed manually or automatically.

Moreover, the manipulator apparatus of this embodiment adopts the outer shape of the holding part 2 (image information) as the above relative spatial information, and the image-processing device 8 obtains the location of the tip x of the manipulating implement 2a as the relative location based on the outer shape of the holding part 2.

According to this constitution, because the image-processing device 8 makes the outer shape of the photographed holding part 2 be the coordinate standard to obtain the location of the tip x of the manipulating implement 2a in the image as the relative location to the coordinate standard, it becomes possible to obtain the location of the tip x of the manipulating implement 2a more accurately.

In addition, in the manipulator apparatus, the outer shape of the holding part 2 used as the above coordinate standard is equipped with a plurality of straight line parts of which an extended line intersects in the location of the tip x of the manipulating implement 2a, and these straight line parts can be photographed as an image in each case in which the holding part 2 is looked at from the two directions of the bottom and the front.

According to this constitution, it becomes possible to obtain the location of the tip x of the manipulating implement 2a in three dimensions more certainly and accurately because it depends on the plurality of straight line parts of which extended line intersects in the location of the tip x of the manipulating implement 2a.

### Second Embodiment

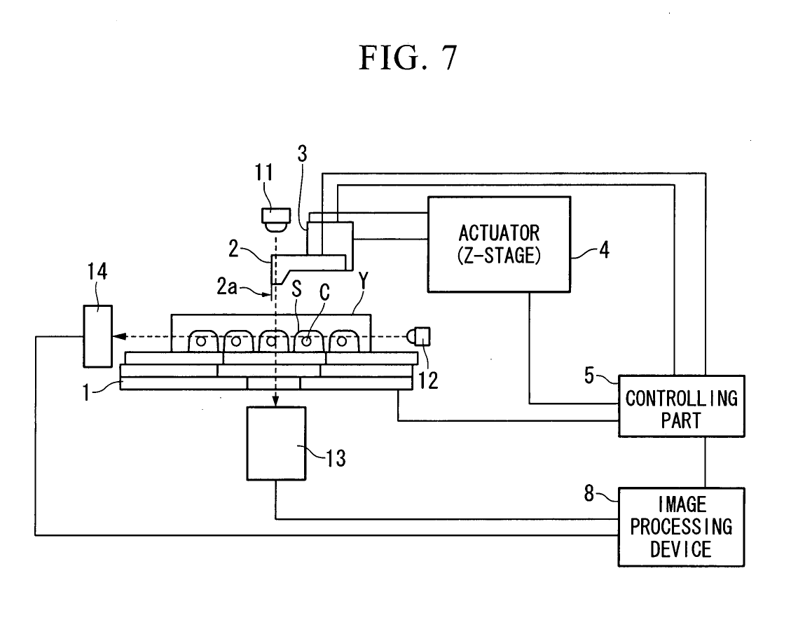

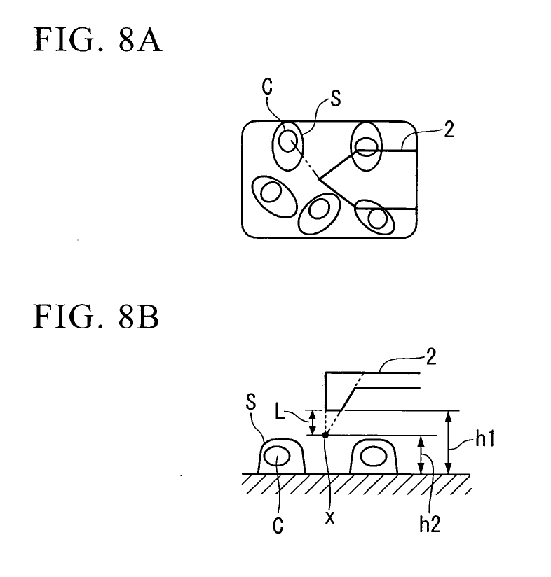

Next, the second embodiment of the present invention will be explained below, referring to FIGS. 7, 8A and 8B. FIG. 7 is a schematic view showing a system constitution. Moreover, FIGS. 8A and 8B are the figures explaining how to recognize the spatial relationship of the manipulating implement tip and the cell in the observing image.

It should be noted that in the explanation of this embodiment, it explains focusing on differences with the above first embodiment, and explanation is omitted noting that it is the same as that of the above first embodiment as to others.

The characteristic of this embodiment is that a combination of light projecting elements 11 and 12 and light receiving elements 13 and 14 is used, instead of the above photographing devices 6 and 7 using CCD.

In addition, the light receiving element 14 which receives a light parallel to the bottom surface of the container Y is used as a laser penetration type size measuring mechanism. In recognizing the spatial relationship in a height direction between the manipulating implement and the bottom surface of the container Y, the lowest surface (however, the shape of the holding part 2 contains the required portion which can be recognized as a reference shape) and the bottom surfaces of the container Y or the cell S are arranged so as to enter into the light path emitted from the light projecting element 12, such that the space from the bottom surface of the container Y or the cell S is measured depending on the distribution state of the laser beam which is emitted from the light projecting element and enters into the light receiving element 14, and then deducting the length of the manipulating implement 2a which is already known in designing and manufacturing timing therefrom to calculate the dimension.

That is, concretely, with reference to FIG. 8B, based on the photographed image, the height dimension h1 between the lower end of the holding part 2 and the bottom surface of the above container Y is obtained first. The height dimension h2 from the location of the tip x of the manipulating implement 2a to the bottom surface of the container Y is computed by deducting the length L of the manipulating implement 2a from this height dimension h1.

In this embodiment, because the space dimension (height dimension) is recognized from the distribution of the penetrating light which depends on the reference shape in a required area, instead of processing each pixel information on the two-dimensional image photographed by a CCD to obtain the space dimension, it is possible to simplify the apparatus constitution. It should be noted that, as for the light receiving element 13 and 14, it is preferred to obtain the location of the tip x of the manipulating implement 2a from the reference shape of the holding part 2 which is recognized using these light projecting elements 11 and 12 and the light receiving units 13 and 14, while enabling all the required portions used as a reference shape among the outer shapes of the holding part 2 to be recognized.

In the manipulator apparatus of this embodiment, it is possible to apply a conventional upright type or conventional inverted type microscope in which the observation optical system having a large magnifying power is arranged only in the direction which crosses the bottom surface of the container Y at a right angle.

### Third Embodiment

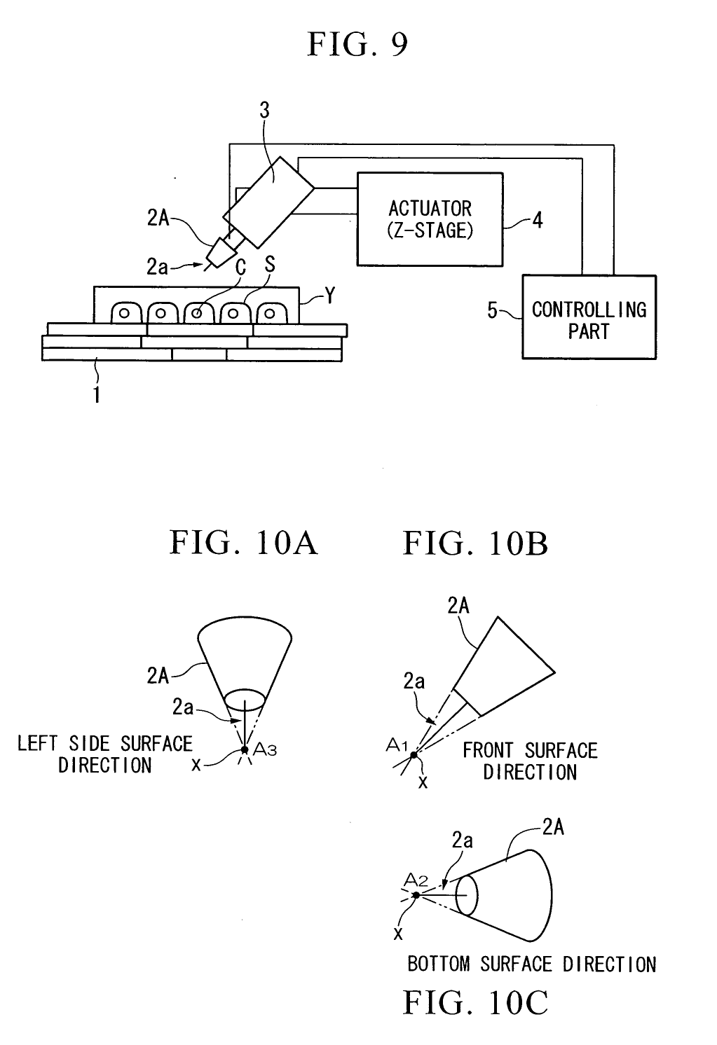

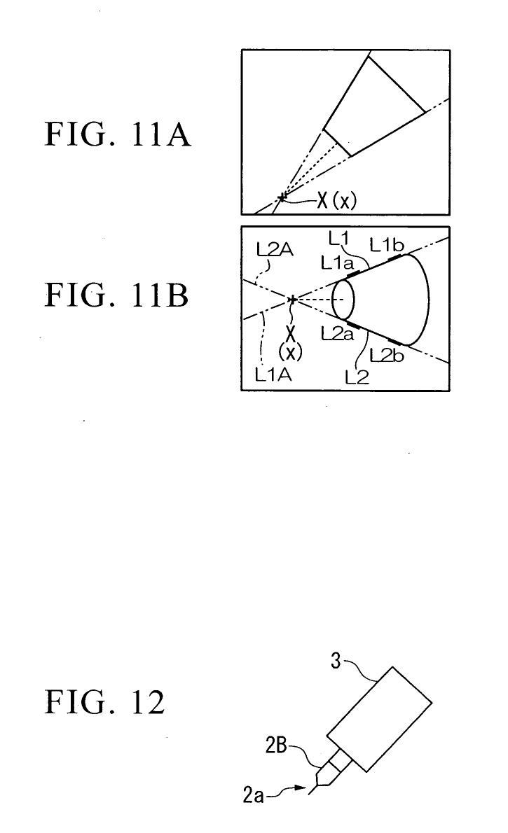

Next, the third embodiment of the present invention will be explained below, referring to FIGS. 9 to 11A, and 11B. FIG. 9 is a schematic view showing a system constitution. Moreover, FIGS. 10A to 10C are figures showing the shape of the holding part. In addition, FIG. 11A and 11B are diagrams for explaining how to recognize the location of the tip x of the manipulating implement 2a from the reference shape by image processing.

It should be noted that, in explaining this embodiment, it is explained focusing on difference with the above first embodiment, and explanation is omitted noting that it is the same as that of the above first embodiment as to others.

In this embodiment, the holding part 2A (in order to distinguish from the holding part 2 of the first embodiment, it is explained using the new symbol 2A.) is arranged such that the axis line of the holding part 2A and the manipulating implement 2a may turn to a slanting lower part, and the operation axis 3 for making the manipulating implement 2a contact or inserted into the cell S is also inclined so as to be parallel to the above axis line, thereby making it be held by the Z stage 4 (it is omitted in FIGS. 9 to 11A and 11B).

The holding part 2A has the same axis line as in the axis of the manipulating implement 2a, and the holding part 2A has an outer shape (image information) of a truncated cone which is tapering off toward the tip x of the manipulating implement 2a, and the holding part 2A is shaped at the time of manufacture, such that the location of the tip x should be located at the top of a truncated cone.

In performing an image processing of the image of the holding part 2A and recognizing the location of the tip x, in the case shown in FIG. 10B where it is looked at from the front, and in the case shown in FIG. 10C where it is looked at from the bottom, respectively, a taper-like outer ridgeline can be detected, and computing the intersections A1 and A2 on the extended line of these outer ridgelines, respectively.

However, in the image looked at from the bottom surface as shown in FIG. 10C, since the focusing position of the outer ridgeline changes continuously in the depth direction of this image, it is preferred to change a focal point in this depth direction, and detecting the same outer ridgeline by at least two or more places to define the straight line accurately. Concretely explaining it, with referring to FIGS. 11A and 11B, a focal point is first matched with each position of point L2a on point L1a and the outer ridgeline L2 on the outer ridgeline L1 shown in FIG. 11B, and the location of such point L1a in this image and L2a is decided. Then, a focal point is matched with each location of point L1b on the outer ridgeline L1 shown in this figure, and L2, and L2b, and the location of such point L1b in this image and L2b is decided. One of two outer ridgelines (L1A) is decided by obtaining the straight line containing point L1a and point L1b. One more outer ridgeline (L2A) is decided by similarly obtaining the straight line containing point L2a and point L2b. It can obtain the position of the intersection X of the extended line of these 2 straight lines as the location of the tip x of the manipulating implement 2a. It should be noted that about the direction of the front shown in FIG. 11A, since the focusing position of an outer ridgeline does not change in the depth direction of the image, each outer ridgeline is decided within a single image, and it can obtain an intersection X.

Since slanting arrangement of the holding part 2A can be performed in this embodiment, it is possible to apply a general manipulator mechanism which has a length in the direction of the axis.

### Fourth Embodiment

Next, the fourth embodiment of the present invention will be explained below, referring to FIGS. 12 to 14A and 14B.

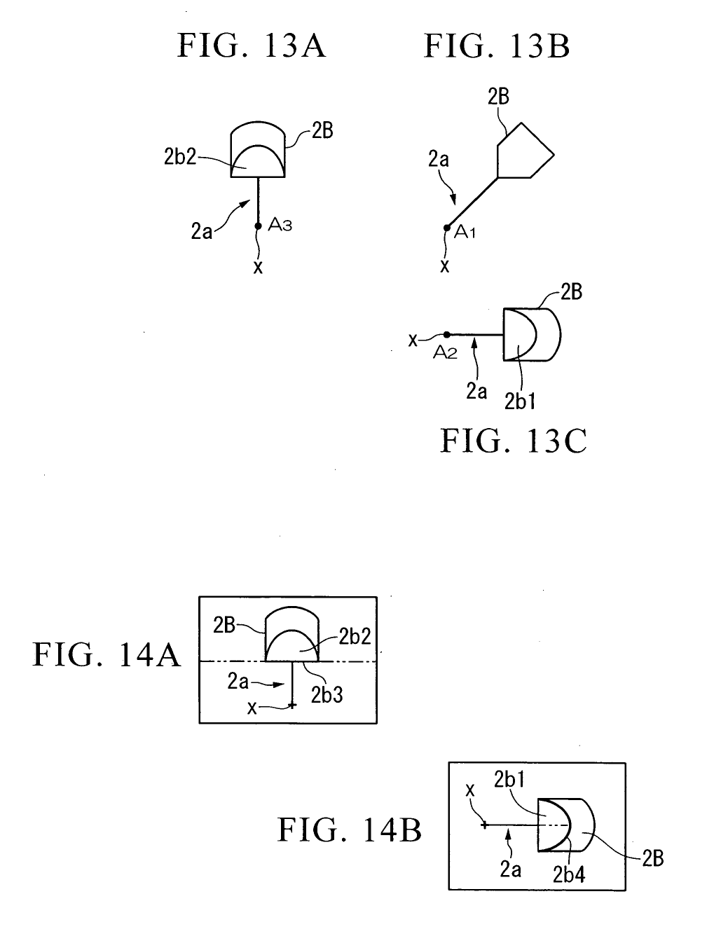

FIG. 12 is a front view showing the holding part attached in the operating axis. Moreover, FIGS. 13A to 13C are figures showing the shape of the holding part. In addition, FIGS. 14A and 14B are diagrams of the image processing for explaining how to recognize the location of the tip x of the manipulating implement 2a from the reference shape.

It should be noted that in explaining this embodiment, it explains focusing on the difference with the above first embodiment, and explanation is omitted noting that it is the same as that of the above first embodiment as to others.

In this embodiment, similarly to the above third embodiment, the holding part 2B (in order to distinguish from the holding part 2 of the first embodiment, or the holding part 2A of the third embodiment, it is explained using the new symbol 2B.) is arranged such that the axis line of the holding part 2B and the manipulating implement 2a may turn to a slanting lower part, and the operating axis 3 for making the manipulating implement 2a be in contact with or inserted into the cell S also inclined so as to be parallel to the above axis line and to be held by the above Z stage 4 (in FIGS. 12 to 14A and 14B, illustration is abbreviated).

The holding part 2B is equipped with an outer ridgeline (image information) being, for example cylindrical, which forms the same axis an in the axis line of the manipulating implement 2a, an end surface 2b1 which is perpendicular to the bottom surface looking direction as shown in FIG. 13C, and an end surface 2b2 which is perpendicular to the left side looking direction as shown in FIG. 13A. The relative spatial relationship between each of these end surfaces 2b1 and 2b2, and the location of the tip of the manipulating implement 2a have been confirmed in the manufacturing process to be well known.

In the case in which the location of the tip x of the manipulating implement 2a is obtained on the basis of the holding part 2B, at first the image looked at from the bottom surface as shown in FIG. 14B and the image looked at from the left side surface as shown in FIG. 14A are captured. In the image looked from the left side surface shown in FIG. 14A, the edge 2b3 which is the straight line portion where the end surface 2b2 and the end surface 2b1 intersected is detected to recognize that the location of the tip x of the manipulating implement 2a presents at a known position from the edge 2b3. On the other hand, in the image looked at from the bottom surface shown in FIG. 14B, the shape of the half-ellipse 2b4 formed by the ridgeline of the end surface 2b1 is recognized as a pattern to recognize that the location of the tip x of the manipulating implement 2a presents at a relatively known position to the pattern. Thus, by obtaining the location of the tip x of the manipulating implement 2a based on the images captured from two directions, it becomes possible as a three-dimensional location on the basis of the holding part 2B to obtain the location of the tip x of the manipulating implement 2a.

As explained in the above, the manipulator apparatus of this embodiment is constituted such that the shape of the holding part 2B has an aspect of an edge (a linear line) 2b3 and another aspect of half-ellipse (curved line) 2b4, in the cases in which the holding part 2b is looked at from the bottom surface direction and is looked at from the left side surface direction, respectively, of which relative locations to the location of the tip x of the manipulating implement 2a are predetermined, and that an arbitrary point which is encompassed within these straight line and the curved line should be apart from the photographing devices 6 and 7, which are the points on which these images are photographed, by the same distance therefrom, respectively.

According to this constitution, even if the holding part 2B is arranged in an inclined state, such that the focusing point of the outer ridgeline should change in the depth direction looked from the photographing device, the images of the edge 2b3 and the half-ellipse 2b4 can be photographed in one sheet in the state where focusing is matched, respectively.

Therefore, it is not necessary to photograph two or more pictures in which the focusing position is changed in the above-mentioned depth direction, and detection of edge 2b3 and the half-ellipse 2b4 can be performed easily, and image processing becomes accurate.

Moreover, for example, it is also possible to recognize that the location of the tip X of the manipulating implement 2a exists in a known position from the edge (the same edge as the edge 2b3), not to recognize it as a pattern from the image shown FIG. 14B. Furthermore, for example, it is also possible to recognize the image shown in FIG. 14A as a pattern, and to recognize that the location of the tip X of the manipulating implement 2a exists on a relative known location to this pattern.

Moreover, as for the manipulator apparatus of this embodiment, a general manipulator as that in the third embodiment can be applied.

### Fifth Embodiment

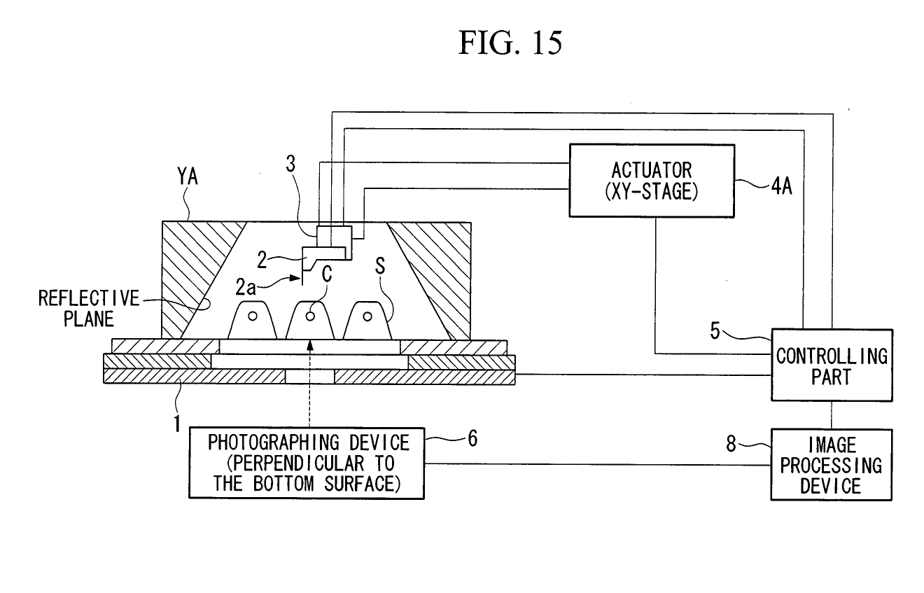

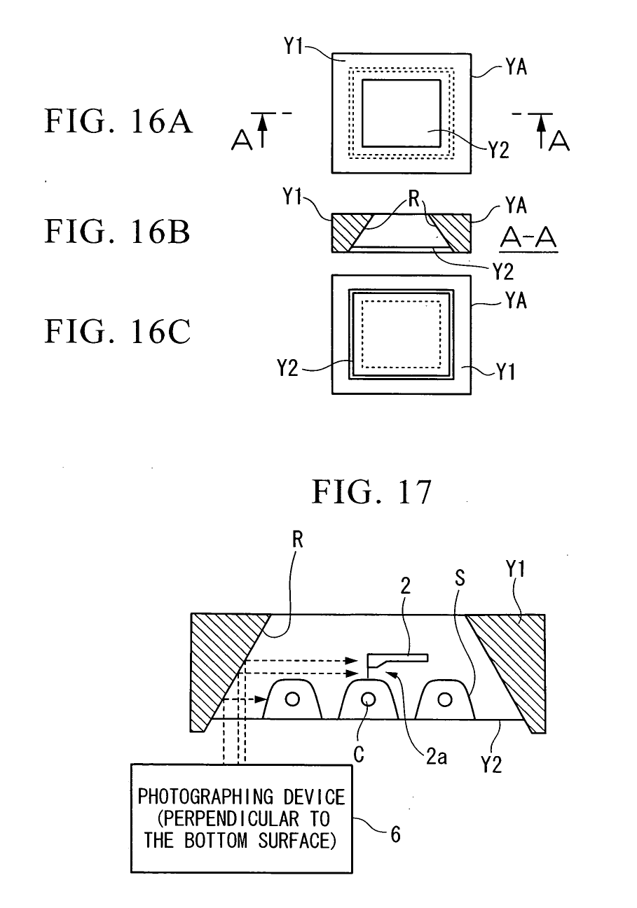

Subsequently, the manipulator apparatus of the present invention and the fifth embodiment of the detecting process of the location of the tip of the manipulating implement will be explained below, referring to FIGS. 15 to 17. FIG. 15 is a schematic view showing a system constitution. Moreover, FIGS. 16A to 16C are figures showing the shape of a container for accommodating a cell. In addition, FIG. 17 is a figure for explaining the observation method using a mirror surface.

It should be noted that, in explaining this embodiment, it is explained focusing on differences with the first embodiment, and explanation is omitted noting that it is the same as that of the first embodiment as to others.

As shown in FIG. 15, in the manipulator apparatus of this embodiment, only the photographing device 6 which photographs in the direction which intersects perpendicularly with the bottom surface of the container is disposed, whereas the photographing device 7 to photograph in a direction parallel to the container bottom surface is omitted. In addition, the holding part 2 is driven by the XYZ stage 4A which drives it in the direction of 3 axes of the direction of the X-axis, the direction of the Y-axis, and the direction of the Z-axis. The XYZ stage 4A has a stopping accuracy of which coordinate control is performed sufficiently, such that positioning of the cell S to a predetermined point should be possible, even if the holding part 2 is displaced to the optical axis of the photographing device 6.

Moreover, as shown in FIGS. 16A to 16C, the manipulator in this embodiment is equipped with a new container YA instead of the above container Y. The container YA is equipped with a side wall part Y1 having a square frame shape, and a transparent bottom wall part Y2 arranged at an opening part which is surrounded by the side wall part Y1. On to the inside surface of the side wall part Y1, four pieces of mirror plate are formed. These mirror plates R are arranged with 45-degree inclination to the bottom wall surface formed by the bottom wall part Y2 to reflect the image being parallel to the bottom surface in the container YA at an incidence angle and 45 degrees of angles of reflection, thereby enabling it to project the image toward the photographing device 6 of right under. Furthermore, the bottom wall part Y2 is raised to the lowest end position of the mirror plate R, to project the image of the bottom wall surface to the mirror plate R.

In the manipulator apparatus having the above constitution, the container YA is displaced by the XY stage, such that the photographing device comes to the right under position of any of the mirror plates, thereby enabling the photographing device 6 to photograph the images of the holding part 2, the cell S, and the bottom wall surface, which are looked from eyes parallel to the bottom wall surface, respectively. In addition, when the container YA is displaced by the XY stage 1 such that the center of the bottom wall part Y2 may come right above the photographing device 6, the photographing device 6 can photograph the image s of the holding part 2 and the cell S, which are looked from the direction intersecting perpendicularly with the bottom wall surface.

In photographing through the mirror plate R, as shown in FIG. 17, the location of the holding part 2 in the XY direction is displaced to a position where it can be photographed as a reflected figure. Photographing is performed after various position adjustments are performed such that the outer shape of the holding part 2 required to recognize the location of the tip x of the manipulating implement 2a (image information), and the bottom wall surface formed by the bottom wall part Y2 or the cell S may be encompassed within the reflected image which is captured by the photographing device 6 through the mirror plate R. Thus, by performing image processing of the photographed image using the above method, the relative spatial relationship in the height direction between the location of the tip x of the manipulating implement 2a and the bottom wall surface or the cell S can be recognized.

As mentioned above, the manipulator apparatus of this embodiment adopts the container YA which is further equipped with the reflective plate (the above mirror plate R) which intersects at 45 degrees to the container bottom surface, in addition to the container described in the (a) of the constituents of (a) to (f) mentioned in the first embodiment.

Thereby, the manipulator apparatus of this embodiment can observe in two directions using the photographing device 6 which is single optical system to recognize the spatial relationship between the location of the tip of the manipulating implement 2a and the cell S in both horizontal direction and height direction, and hence conventional constitutions of an upright type and an inverted type optical microscope can be applied to the manipulator apparatus.

More concretely, the manipulator apparatus of this embodiment captures the image of the holding part 2 which is directly photographed from the bottom surface direction not via the mirror plate R and the image of the holding part 2 which is photographed from the side direction via the mirror plate R, thereby enabling it to photograph the image of the holding part 2 which is looked from two different direction, from the line of sight in the same direction. This enables to omit the above photographing device 7 in the first embodiment.

In addition, because the height position of the above bottom wall part Y2 is arranged so as to be higher than the lowest end position of the mirror plate R, in photographing the image which is captured by looking inside the container YA via the mirror plate R from the side direction, it is possible to project the bottom wall surface of the container YA within the image. Therefore, it becomes possible to photograph vividly the image including the bottom surface position of the cell S.

Moreover, because what is necessary is to arrange the photographing device 6 which is the observation optical system having a large magnifying power only in the direction which intersects perpendicularly with the above bottom wall surface, it is possible to employ a usual microscope.

It should be noted that it is of course possible to adopt the constitution of moving the optical axis of the photographing device 6 side to the holding part 2, instead of displacing the holding part 2 from the optical axis on the XYZ stage 4A in order to observe the holding part 2 with a reflected image.

### Sixth Embodiment

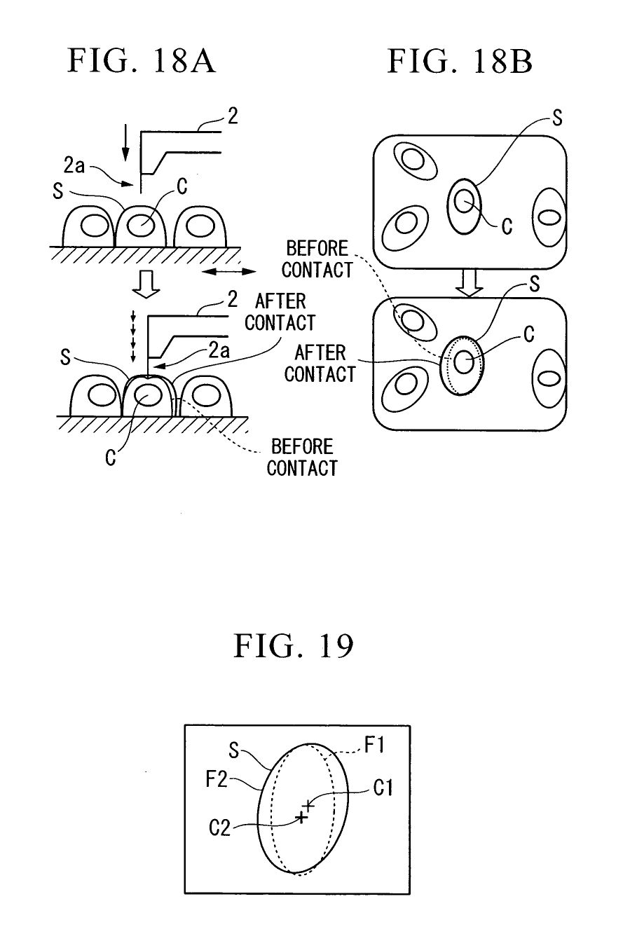

Next, the sixth embodiment of the present invention will be explained below, referring to FIGS. 18A, 18B, and 19. FIG. 18A is a figure for explaining contact operation of the manipulating implement to the cell, and FIG. 18B is the observation image which looked at the cell before and after the manipulating implement comes into contact from the top. Moreover, FIG. 19 is a figure explaining the way how the image processing detects a modification of the cell.

In FIG. 19, F1 shows the outline of the sample before contact, C1 shows the center of gravity of the area surrounded by F1, and A1 shows the dimensions of the area surrounded by F1. Similarly, F2 shows the outline of the sample after contact, C2 shows the center of gravity of the area surrounded by F2, and A2 shows the dimensions of the area surrounded by F2. It is referred to as C1≠C1 or A1≠A2 as image-processing judging conditions.

It should be noted that in the explanation of this embodiment, it is explained focusing on difference with the first embodiment, and explanation is omitted noting that it is the same as that of the first embodiment as to others.

In this embodiment, as mentioned in the above, the point of obtaining the location of the tip x of the manipulating implement 2a at first based on the reference shape of the holding part 2, then correcting the calculation error of the location of the tip x due to the manufacturing error of the holding part 2, etc., thereby rediscovering the strict spatial relationship in the height direction between the cell S or the bottom surface of the container Y and the location of the tip x of the manipulating implement 2a is especially characteristic. It should be noted that this rediscovering operation can be performed not only in the first embodiment, but also in combination of any of the second embodiment to the fifth embodiment.

The rediscovering operation in the above will be explained more in detail. First, as shown in FIG. 18A upper figure, each actuator is controlled by the controlling part 5 in three dimensions to move the holding part 2 to right above position of the cell S upper end, thereby making the manipulating implement 2a into the state where contact or insertion is possible for the cell S. The state at this time where the manipulating implement 2a does not touch the cell S is shown in FIG. 18B upper figure. By driving intermittently the actuator of the Z stage 4 or the operation axis 3 with a minute and fixed pitch, as shown in FIG. 18A lower figure, the location of the tip x of the manipulating implement 2a is displaced intermittently to be approached to the cell S.

At this time, as shown in the upper figure and the lower figure in FIG. 18B, by the photographing device 6 and the image processing device 8, the images of the cell S before and after each displacing step of the holding part 2 are subjected to the image processing to be compared, respectively.

Thereby, the minute modification which generates in the cell S when the location of the tip x comes into contact slightly with the cell S of the manipulating implement 2a can be detected.

The actuator of the operating axis 3 is stopped once immediately after detection of this modification, and the location before and after or the middle of the driving of the step in which the modification is detected is recognized as an exact contact position. The position where the actuator of the operating axis 3 is stopped or returned therefrom by a fixed quantity is redefined as the manipulation starting point, and actual contact operation or insertion operation is controlled based thereon.

As a method for detecting minute modification of the cell S, it is possible to adapt a method which captures the movement in XY plane of the cell S or a method which captures flattening of the cell S, by detecting the center-of-gravity position change (position change of the point P1 mentioned in the above in FIGS. 5A and 5B) to the outline of the cell S, or the change of dimensions formed by the outline of the cell S.

This will be concretely explained referring to FIG. 19 below. The outline of the cell S changes into F2 after contact from F1 before contact by the contact of the location of the tip x of the manipulating implement 2a. This is accompanied by moving the center-of-gravity position of the cell S to the point C2 after contact from the point C1 before contact. Similarly, the dimensions formed by the outline of the cell S becomes larger toward A2 after the contact from A1 before contact by flattening of the cell S. Therefore, it becomes possible by capturing one or both of these center-of-gravity position change and dimensions change to catch shape change or movement of the cell S.

It should be noted that in a setup of the threshold value which judges the existence of modification, for example, the threshold value is set to be 1.5 times of the size error of measurement at the time of measuring the image of the cell S which does not generate modification. However, the magnifying power of 1.5 is not restrictive, and hence it is possible to adapt a magnifying power over 1 according to a measurement situation.

As mentioned in the above, by performing the rediscovering operation of this embodiment, it is possible to rediscover the restrict spatial relationship between the location of the tip x of the manipulating implement 2a and the cell S, thereby exerting the effect when the restrict control of the depth of insertion is necessary.

The manipulator apparatus of this embodiment having the constitution explained in the above adapts the constitution that the image processing device 8, which serves both as the image processing device and the judging device, judges at least one of the center-of-gravity position change and the dimensions change formed by the outer shape of the cell S, based on the image photographed by the photographing device 6.

According to this constitution, it becomes possible to confirm certainly whether the presumed results of the first embodiment to the fifth embodiment are correct by comparing the location of the tip x of the manipulating implement 2a which is obtained in the first embodiment to the fifth embodiment with the location of the tip x of the manipulating implement 2a which is obtained in the above rediscovering operation. In addition, because this rediscovering operation is suitable for automation, and hence the rediscovering operation is suitable for advancing automation of control of this manipulator apparatus.

### Seventh Embodiment

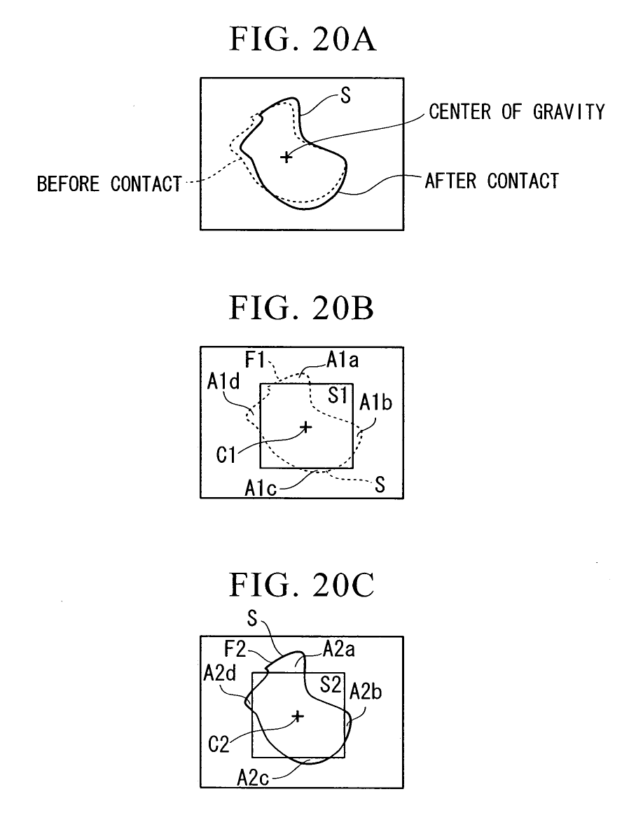

Subsequently, the seventh embodiment of the present invention will be explained below, referring to FIGS. 20A to 20C. FIGS. 20A to 20C are figures explaining how the image processing detects a modification of the cell.

In FIGS. 20A to 20C, F1 shows the outline of the sample before contact, C1 shows the center of gravity of the area surrounded by F1, and A1 shows the dimensions of the area surrounded by F1. Similarly, F2 shows the outline of the sample after contact, C2 shows the center of gravity of the area surrounded by F2, and A2 shows the dimensions of the area surrounded by F2. S1 indicates a square of which center of gravity presents on C1, and of which dimensions is equivalent to A1, A1a indicates the dimensions of the are surrounded by F1 and S1 upper side, A1b indicates the dimensions of the area surrounded by F1 and S1 right-hand side, A1c indicates the dimensions of the area surrounded by F1 and S1 lower side, and A1d indicates the dimensions of the area surrounded by the F1 and S1 left side. S2 indicates a square of which the center of gravity presents on C2 and of which dimensions are equivalent to those of A2, A2a indicates the dimensions of the area surrounded by F2 and S2 upper side, A2b indicates the dimensions of the area surrounded by F2 and S2 right-hand side, A2c indicates the dimensions of the area surrounded by F2 and S2 lower side, and A2d indicates the dimensions of the area surrounded by F2 and S2 left side is shown A2d.

As the image-processing judging conditions, it is set as C1≠C2, A1a≠A2a, A1b≠A2b, A1c≠A2c, or A1d≠A2d.

It should be noted that in explaining this embodiment, it is explained focusing on difference with the first embodiment, and explanation is omitted noting that it is the same as that of the first embodiment as to others.

In this embodiment, similar to the sixth embodiment, the point of obtaining the location of the tip x of the manipulating implement 2a based on the reference shape of the holding part 2 first, then correcting the calculation error of the location of the tip x due to the manufacturing error of the holding part 2, etc., thereby rediscovering the strict spatial relationship between the cell S or the bottom surface of the container Y and the location of the tip x of the manipulating implement 2a in the height direction is especially characteristic. Furthermore, in this embodiment, the shape of the cell S on the image is divided into plurality of areas, and the contact of the location of the tip x of the manipulating implement 2a with the cell S is judged, based on the change of the image information of at least one area of these areas.

It should be noted that the above rediscovering operation can be performed not only in the first embodiment but also in any of combination of the second embodiment to the sixth embodiment.

The rediscovering operation will be explained in detail below. At first, each actuator is controlled by the above controlling part 5 (not shown) in three dimensions to displace the holding part 2 to a right above position of the cell S upper end, thereby enabling the manipulating implement 2a to be in contact with or inserted to the cell S. The state at this time where the manipulating implement 2a is not in contact with the cell S is shown by the dashed line of FIG. 20A. The location of the tip x of the manipulating implement 2a is displaced intermittently to be approached to the cell S by driving intermittently the actuator of the Z stage 4 or (not shown) the operating axis 3 by a minute and fixed pitch. The state where the manipulating implement 2a is in contact with the cell S is shown by the solid line in FIG. 20A.

In the rediscovering operation in this embodiment, the center-of-gravity position and the outline of the cell S are confirmed on the image, each time the actuator is driven by one pitch. This is in the state shown in FIG. 20A.

At this time, as shown in FIG. 20B, the square S1 of which dimensions are equivalent to the dimensions of the area formed by the outline of the cell S in the image before being displaced by one pitch is defined, and the square S1 is superimposed onto the cell S such that the center may fit in the center of gravity C1 and C2 of the cell S. Then, as shown in FIG. 20B, because a plurality of areas (in this figure, four areas) which are overflowed from the square S1, i.e., the areas formed by the outline of the cell S and the sides of the square S1, are formed, it is possible to capture the modification of the cell S by detecting the dimensions change of any of the areas.

More concretely, when comparing FIG. 20B with FIG. 20C, the correlations between dimensions of areas will be: dimensions A1a<dimensions A2a, dimensions A1b>dimensions A2b and dimensions A1c<dimensions A2c, dimensions A1d>dimensions A2d, and dimensions change has arisen in all portions. Of course, it is possible to judge that the modification occurs in the case in which dimension change is generated in at least one portion, even if dimension change is not generated in all parts.

The manipulator apparatus of this embodiment mentioned in the above adapts the constitution which detects minute modification of the living organism sample (the cell S in the above) from the constitution similar to one including (a) to (f) explained in the first embodiment. Concretely, in the manipulator apparatus of this embodiment, the image processing device 8, which serves both as the image processing device and the judging device, covers the image of the cell S with the square (virtual covering plate) S1, such that margin parts which includes ridgeline which forms outline of the cell S might be overflowed and isolated to judge the dimensions change of the margin parts.

Similar to the first embodiment, the spatial relationship between the coordinate of the location of the tip x of the manipulating implement 2a and the coordinate of the manipulated object point of the cell S is roughly recognized, each actuator (the above XY stage 1 and the above Z stage 4) is controlled in three dimensions by the controlling device 5 such that the tip of the manipulating implement 2a is displaced to the manipulated object point of the cell S so as to enable the manipulating implement 2a to be in contact with or inserted into the cell S, and the step driving of the operating axis 3 in the contact or the insertion direction is further performed intermittently at a low speed by a minute fixed pitch near the position where the contact or insertion of becomes possible.

At this time, the minute modification which generates in the cell S when the tip and the cell S of the manipulating implement 2a comes into contact slightly is detected by image processing and comparing the images of the cell S before and after each step using the photographing devices 6 and 7 and the image-processing device 8. After the modification is detected, the operating axis 3 is stopped once immediately after detection of this modification, and the location before and after or the middle of the driving of the step in which the modification is detected is recognized as an exact contact position. The position where the actuator of the operating axis 3 is stopped or returned therefrom by a fixed quantity is redefined as the operation starting point, and actual contact operation or insertion operation is controlled based thereon.

Thereby, it becomes possible to correct the calculation error of the location of the tip based on the reference shape of the holding part 2 and the manufacturing error as to the relative spatial relationship between the manipulating implement 2a and the holding part 2 to recognize strict spatial relationship between the manipulating implement 2a and the cell S. Therefore, because the modification of the cell S can be certainly caught even when it is difficult to distinct only by center-of-gravity position change and dimensions change of the cell S, it becomes possible still to ensure rediscovering operation of the location of the tip x of the manipulating implement 2a. In addition, only the compression stress in the direction of the axis of the manipulating implement 2a acts slightly on the manipulating implement 2a, there is no possibility of breaking the tip of the manipulating implement 2a.

Moreover, it becomes possible to use the above constitution in combination with a photographing device, which has the recognizing device in the height direction depending thereon, and which photographs in the direction intersecting perpendicularly the bottom surface by one optical system, that is, a conventional upright type or inverted type microscope.

It should be noted that the detecting the modification of the cell S can be automatically recognized by image processing, and it is also possible to visualize it to be recognized visually. Moreover, S1 is not limited to a square, and hence, S1 may be other figures, such as a rectangle, other polygons and a circle, and an ellipse. In addition, what is necessary is that the image of the cell S can be divided into a plurality of areas, and hence it is also possible to divide the image of the cell S by a straight line or a curved line into a plurality of areas, and the modification of at least one of the plurality of areas is confirmed, thereby recognizing the contact of the manipulating implement 2a with the cell S.

### Eighth Embodiment

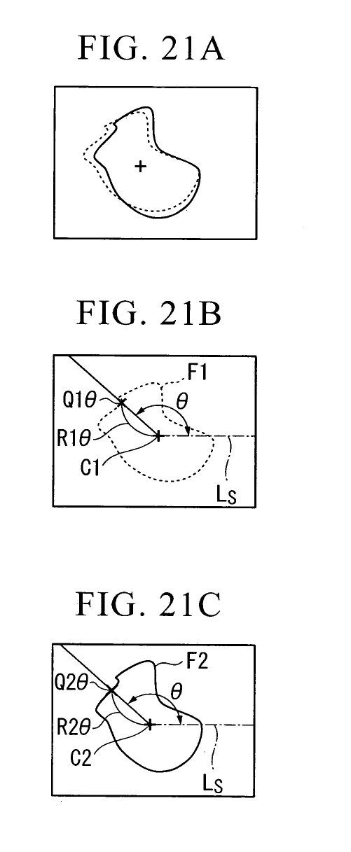

Then, the eighth embodiment of the present invention will be explained below, referring to FIGS. 21A to 21C. FIGS. 21A to 21C are figures explaining how image processing detects the modification of a cell.

In FIGS. 21A to 21C, F1 denotes the outline of the sample before contact, and C1 denotes the center of gravity of the area surrounded by F1. Like the following, F2 denotes the outline of the sample after contact, and C2 denotes the center of gravity of the area surrounded by F2. Q1θ denotes an intersection of the straight line which is passing through C1 and inclined by θ from the standard, and Q2θ denotes an intersection of the straight line which is passing through C2 and inclined by θ from the standard. R1θ denotes the distance between C1 and Q1θ, and R2θ denotes the distance between C2 and Q2θ.

As image-processing judging conditions, it is considered as C1≠C2 or R1θ≠R 2θ (provided that, θ=10°, 20° . . . 360°).

It should be noted that in explaining this embodiment, it is explained focusing on difference with the first embodiment, and explanation is omitted noting that it is the same as that of the first embodiment as to others.

In this embodiment, similar to the sixth embodiment, the point of obtaining the location of the tip x of the manipulating implement 2a based on the reference shape of the holding part 2 first, then correcting the calculation error of the location of the tip x due to the manufacturing error of the holding part 2, etc., thereby rediscovering the strict spatial relationship between the cell S or the bottom surface of the container Y and the location of the tip x of the manipulating implement 2a in the height direction is especially characteristic.

It should be noted that the above rediscovering operation can be performed not only in the first embodiment but also in any of combination of the second embodiment to the seventh embodiment.

The rediscovering operation will be explained in detail below. First, each actuator is controlled by the above controlling part 5 which is not shown in the drawings, in three dimensions to displace the holding part 2 to right above a position of the cell S upper end, thereby enabling the manipulating implement 2a to be in contact with or inserted into the cell S. The state at this time where the manipulating implement 2a is not in contact with the cell S is shown by the dashed line of FIG. 21A. The location of the tip x of the manipulating implement 2a is displaced intermittently to be approached to the cell S by driving intermittently the actuator of the Z stage 4 or (not shown) the operating axis 3 by a minute and fixed pitch. The state where the manipulating implement 2a is in contact with the cell S is shown by the figure drawn by the solid line in FIG. 21A.

In the rediscovering operation in this embodiment, the center-of-gravity position and the outline of the cell S are confirmed on the image, each time the actuator is driven by one pitch. As shown in FIG. 21B, the standard straight line Ls which passes through the center of gravity C1 of the cell S is set up on the image.

The standard straight line Ls is, for example, rotated counterclockwise around the center of gravity C1, such that the intersection on which the standard straight line Ls crosses the outline of the cell S is set to Q10 to acquire the distance R1θ between Q1θ and the center of gravity C1 at every angle θ. As a result, in the case in which before and after the actuator of the operating axis 3 is advanced by a minute and a fixed pitch, the length of R1θ in the angle θ changes into the length R2θ shown in FIG. 21C, it is judged that the outline of the cell S deformed at that portion. It should be noted that the θ is set at a fixed pitch, and that in order to improve the detecting accuracy, the θ should be set at a finer pitch. In addition, it is also possible to judge by change of the location of Q2θ.

As mentioned in the above, in the manipulator apparatus of this embodiment, the image-processing device 8 which serves both as the image-processing device and a distinguishing device set up the center-of-gravity position (other arbitrary points are employable) to the image of the cell S to judge change of the distance between center-of-gravity position and each point Q1θ on the ridgeline which forms the outer shape of the cell S.

According to the above constitution, it is preferred to catch directly the change of the outer shape of the cell S as a dimensional change, as in this embodiment, when distinction of modification is difficult even if depending on the change of the center-of-gravity position of the cell S, dimensions change, or the dimensions change of the margin.

Hereby it is possible to detect local modification in which dimensions does not change clearly, and hence it becomes possible still to ensure detecting the location of the tip x of the manipulating implement 2a by the image-processing device 8.

### Ninth Embodiment

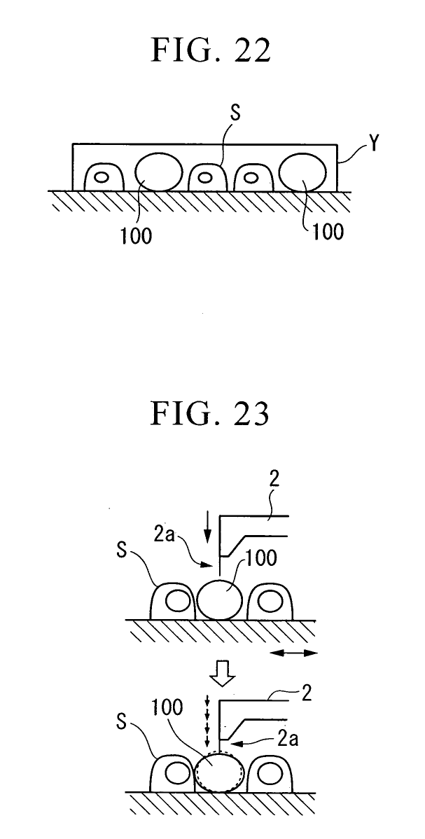

Next, the ninth embodiment of the present invention will be explained below, referring to FIGS. 22 to 24.

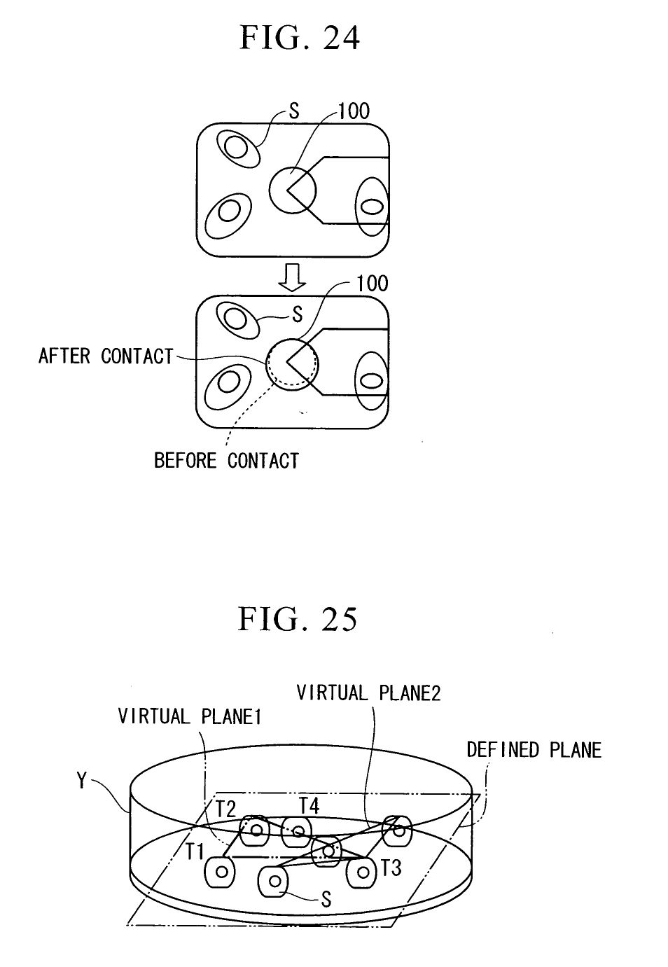

FIG. 22 is a figure showing the simulated living organism sample and cell which have been arranged in a container. Moreover, FIG. 23 is a figure explaining contact operation to the simulated living organism sample by the holding part. Moreover, FIG. 24 is a plan view for explaining the modification detection method by the observation image and image processing of a simulated living organism sample before and after contact.

In FIG. 24, F1 denotes the outline of the sample before contact, C1 denotes the center of gravity of the area surrounded by F1, and A1 denotes the dimensions of the area surrounded by F1. Similarly, F2 denotes the outline of the sample after contact, C2 denotes the center of gravity of the area surrounded by F2, and A2 denotes the dimensions of the area surrounded by F2. It is referred to as C1≠C1 or A1≠A2 as image-processing judging conditions. It should be noted that in explaining this embodiment, it is explained focusing on differences with the first embodiment, and explanation is omitted noting that it is the same as that of the first embodiment as to others.

In this embodiment, similar to the sixth embodiment, the point of obtaining the location of the tip x of the manipulating implement 2a based on the reference shape of the holding part 2 at first, then correcting the calculation error of the location of the tip x due to the manufacturing error of the holding part 2, etc., thereby rediscovering the strict spatial relationship between the cell S or the bottom surface of the container Y and the location of the tip x of the manipulating implement 2a in the height direction is especially characteristic. In this embodiment, the target with which the location of the tip x of the manipulating implement 2a comes into contact in the rediscovering operation is not the cell S but the simulated living organism sample 100 of which size and shape are known.

It should be noted that the above rediscovering operation can be performed not only in the first embodiment but also in any of a combination of the second embodiment to the eighth embodiment.

The rediscovering operation will be explained in detail below. At first, as shown in FIG. 22, a fine and spherical simulated living organism sample 100 which has a fixed and known dimension and shape being made of resin being softer than the cell S is dispersed and held at the bottom surface of the container Y in which the cell S to be operated is accommodated.

If each size is known, shape and the dimension of the simulated living organism sample 100 is not necessarily fixed.

Each actuator is controlled by the controlling part 5 in three dimensions to displace the holding part 2 to a position right above the upper end of the simulated living organism sample 100 presents near the cell which is an operation target, thereby enabling the holding part 2 to be in contact with or inserted into the simulated living organism sample 100. The state where the manipulating implement 2a at this time is not in contact with the simulated living organism sample 100 is shown in FIG. 23 lower figure and FIG. 24 lower figure. In the rediscovering operation in this embodiment, change of dimensions formed by the outline of the pseudo living organism or change of the center of gravity of the simulated living organism sample 100 is observed each time the actuator is driven by one pitch to observe whether one or both of them changes or not, on the image processing device 8. In the case in which change is observed in any of them, it is judged that the location of the tip x of the manipulating implement 2a comes into contact with the upper end of the simulated living organism sample 100 to be deformed.

Since the height of the simulated living organism sample 100 is known, the location of the tip x of the manipulating implement 2a at the time of deformation can be correctly obtained by determining that the location of the tip x of the manipulating implement 2a is present at the position which is apart from the bottom surface of the container Y in the height direction by the height of the simulated living organism sample 100. This result is corrected by compared with the location of the tip x of the manipulating implement 2a which is obtained based on the reference shape of the holding part 2.

According to the above rediscovering operation, an exact location of the tip x to the bottom surface of the container Y can be obtained, based on this, the operation starting point for performing an operation to the cell S is defined. The location of the tip x of the manipulating implement 2a is arranged to the operation starting point to perform actual contact or insertion operation.

It should be noted that as for the threshold value in judging whether the simulated living organism sample 100 deforms or not, and whether the simulated living organism sample 100 is displaced or not, for example, the threshold value should be 1.5 times of the error which is obtained by measuring the simulated living organism sample 100 in the absence of external force. Of course, this threshold value is merely an example and the magnifying power of 1.5 times is not restrictive, and hence the other magnifying power which may over 1.5 times can be set up suitably according to a measurement situation.

As mentioned in the above, in this embodiment, in the same constitution as the first embodiment, the granular simulated living organism sample 100 which is made of material being softer than the cell S and of which size is known is dispersed and held in the container Y as well as the cell S, such that the image processing device 8 processes the image to recognize the coordinate of the point specified from the image, thereby detecting the minute deformation in the simulated living organism sample 100.

By being equipped with such constitution, the outline of relative spatial relationship between the coordinated of the location of the tip x of the manipulating implement 2a and the coordinate of the upper end of the simulated living organism sample 100 held near the cell which is the target of the operation is recognized, and each actuator (the XY stage 1 and the Z stage 4) is controlled in the three dimensions by the controlling device 5 such that the location of the tip x of the manipulating implement 2a is displaced to the upper end of the simulated living organism sample 100, thereby enabling the manipulating implement 2a to be in contact with or inserted into the simulated living organism sample 100, and further the operating axis 3 is stepwise driven at a low speed and a fixed fine pitch intermittently near the location where the contact or insertion becomes possible in the direction of contact or insertion.

At this time, by processing and comparing the image of the simulated living organism sample 100 before and after each step using the photographing devices 6 and 7 and the image-processing device 8, a slight deformation, which occurs when the tip of the manipulating implement 2a comes into contact slightly or contacts the simulated living organism sample 100, is detected. The operating axis 3 is once stopped immediately after this modification is detected, and the location before and after driving the step where the deformation is confirmed or the middle thereof is recognized to be the exact contact position to recognize the location of the bottom surface of the container Y exactly based on this location and the height of the upper end of the simulated living organism sample 100, thereby controlling the insertion depth into the cell S based on this to control actual contact or insertion.

This corrects the calculation error of the location of the tip of the manipulating implement 2a, and the manufacturing error about the relative spatial relationship between the manipulating implement 2a and the holding part 2, such that strict spatial relationship between the tip of the manipulating implement 2a and the bottom surface of the container Y can be recognized through the simulated living organism sample 100 of which size and shape are known, and the spatial relationship to the cell S in the height direction can be forecasted, in addition, it can be avoided that the manipulating implement 2a bashes against the bottom surface to be broken even when the size and shape of the cell S are uneven.

Moreover, it becomes possible to use the above constitution in combination with a photographing device, which has the recognizing device in the height direction depending thereon, and which photographs in the direction intersecting perpendicularly the bottom surface by one optical system, that is, a conventional upright type or inverted type microscope.

It should be noted that, although only the compression stress in the direction of the axis acts on the manipulating implement 2a slightly, since this stress is suppressed still more slightly compared with the case in which the manipulating implement 2a comes into contact with the cell, by the quality of the material of the simulated living organism sample 100, it cannot break the tip. Moreover, the detection of modification can be automatically recognized by image processing, and it can be visualized to be visually recognized.

It should be noted that, as the simulated living organism sample 100, it is preferred to choose the material which is easy to detect modification compared with the cell S, and the material which can suppress the anti-power to the manipulating implement 2a, upon being in contact with the manipulating implement 2a.

### Tenth Embodiment

Then, the tenth embodiment of the present invention will be explained below, referring to FIG. 25. FIG. 25 is a figure for explaining the definition of a plane and the method for calculating the height of an arbitrary part by the coordinates of three portions.

It should be noted that since this embodiment corresponds to the modification of the first embodiment to the ninth embodiment, it will be explained focusing on the difference among these embodiments, and explanations on the others are omitted noting that they are the same as those of the above embodiments.

In this embodiment, as shown in FIG. 25, the above mentioned device is used to the three portions in the container Y (three pieces of the cell S) to obtain the spatial relationships between the upper end of the location of the tip x of the manipulating implement 2a, and the upper end of the cell S or the bottom surface of the container Y, respectively. The bottom of the container Y or the upper end of each cell S is expressed by the points T1 to T3 of a common space coordinates system to define a virtual plane including these points.

The virtual plane is defined as a plane which passes through three points T1 to T3 in a space and of which coordinate is expressed by the numerical formulae (1) to (3), and it is presumed that bottom or upper end of arbitrary cell S in the container Y exists on the virtual plane. The height Z of the virtual plane at an arbitrary location can be computed by substituting XY coordinate of arbitrary location for x and y in the numerical formulae (1) to (3) which specifies the virtual plane.

The arbitrary point (x, y, z) on a virtual plane including a point T1(x1,y1,z1), a point T2 (x2, y2, z2), and a point T3 (x3, y3, z3) satisfies the following numerical formulae (1) to (3):
x=x1+(x2−x1)s+(x3−x1)t (1)
y=y1+(y2−y1)s+(y3−y1)t (2)
z=z1+(z2−z1)s+(z3−z1)t (3)

Moreover, the z coordinate in the point T4 (x4,y4,z4) of which x coordinate and y coordinate are known can be obtained as x=x4 and y=y4 by deleting s and t in the numerical formulae (1) to (3).

In this embodiment explained in the above, the controlling part 5 recognizes virtually a plane including the bottom surface of the container Y or the upper end of the arbitrary cell S, based on the spatial relationship in the height direction between the tip of the manipulating implement 2a and the bottom surface of the container Y or the upper end of the cell S, at a plurality of portions in the container Y.

The controlling part 5 recognizes the spatial relationship in the height direction between the tip of the manipulating implement 2a and the bottom surface of the container Y or the upper end of the cell S at three or more portions in the container Y to express the bottom surface of the container Y or the upper end of the cell S by the points of a common space coordinates system, and the controlling part 5 defines the most average plane which includes these points to presume that the bottom or top end of an arbitrary cell S in the container exists on the plane.

Thereby, it becomes unnecessary to recognize the spatial relationship between the tip of the manipulating implement 2a and an arbitrary cell S individually, because the spatial relationship between the tip of the manipulating implement 2a and an arbitrary cell S is presumed virtually entirely in the container Y, based on the recognition at a representative point. In addition, it becomes possible to perform positioning efficiently by omitting useless motion in the height direction to a plurality of cells S.

Further, it becomes possible to perform presuming as to an arbitrary cell S more exactly, by performing the recognition of spatial relationship at four or more of points, and choosing a plurality of combinations of three points to adapt an average of plane which is defined by each three points.

More concretely, in this embodiment, a virtual plane which includes upper end or bottom of each of three or more of the cells S is formed, and the relative spatial relationship between the virtual plane and the location of the tip x of the manipulating implement 2a.

Thereby, for example, it can be accommodate even if the bottom surface of the container Y on which each cell S is loaded is inclined. That is, when the surface on which each cell S is loaded is inclined, it is not sufficient to obtain the relative spatial relationship between the cell S and the manipulating implement 2a with respect to one cell S only, because the same relative spatial relationship may not apply to the other cells S.

Then, by making the manipulating implement 2a be in contact with three or more of cells S, while considering the above inclination, it is possible to obtain the virtual plane which shows the height position coordinate of the upper end or the position coordinate of the bottom of each cell S. It becomes possible to use the virtual plane as a standard in obtaining the location of the tip x of the manipulating implement 2a.

Therefore, since the spatial relationship between the manipulating implement 2a and the arbitrary cells S can be virtually determined, based on the recognition of a representative point, when the size of the cell S in Container Y is relatively fixed, it becomes unnecessary to recognize the height of each cell S individually.

On the other hand, when the size of each cell S in the container Y varies by a certain amount, it is necessary to recognize the height of each cell S individually, however, it is possible to determine the position at a safe height where the manipulating implement 2a can approach the cell S without contacting therewith, thereby improving working efficiency.

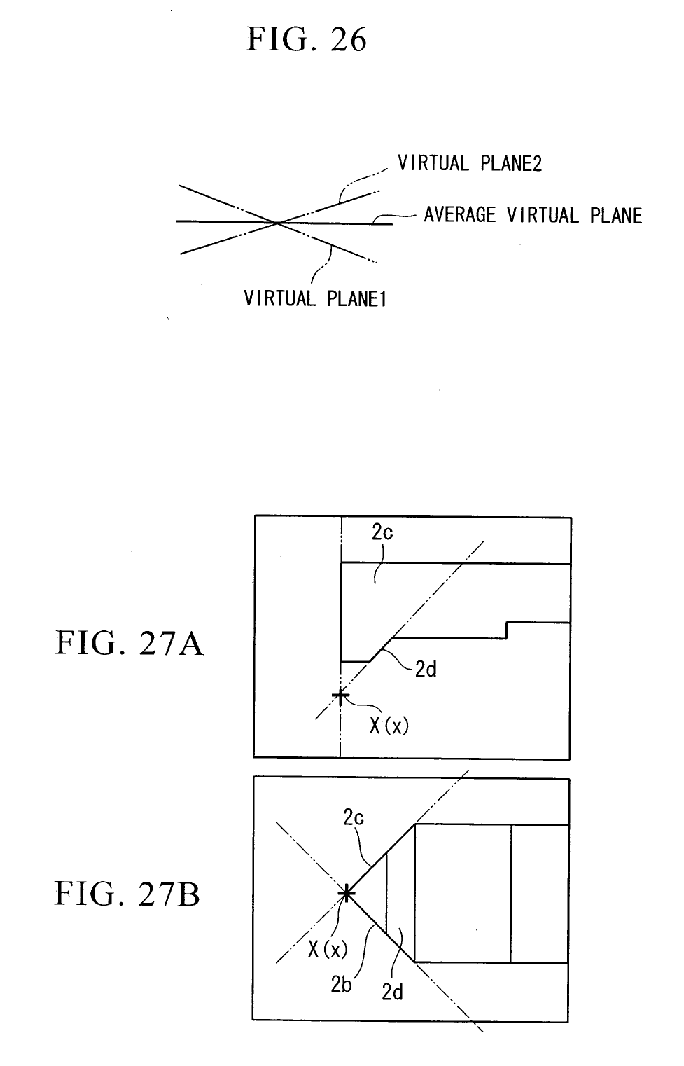

In addition, when sufficient flatness of the bottom surface of the container Y cannot be obtained, as shown in FIG. 25, the above recognition of spatial relationship in the height direction are performed on four or more of points to form a plurality of virtual planes which are formed by the combination of three points among these points (the virtual plane 1, the virtual plane 2). For example, by performing the recognition on four points, four ways of virtual plane can be formed through the combination of three points among the four points. As shown in FIG. 26, by obtaining a virtual plane having the average inclination of the inclination of these virtual planes, it becomes possible to perform determination as to an arbitrary cell S more exactly.

It should be noted that in each embodiment mentioned in the above, it is explained with referring to the case in which the present invention is applied to the manipulator apparatus (apparatus); however, the present invention is not limited thereto, and it is also possible to apply the present invention to the other apparatus which is equipped with an manipulating device which is difficult (not visible or hard to see) to be confirmed by photographing, such as an image processing apparatus which presumes the location of the tip of the manipulating device which is held thereto, based on the image of the holding device of which size can be detected by photographing.

Moreover, the present invention is used for a controlling device for controlling an apparatus which is equipped with a manipulating device for manipulating an manipulated object, a holding device for holding the manipulating device of which size can be detected by photographing, an image capturing device which captures an image which includes the holding device, and a presuming device which presumes the location of the tip of the manipulating device, based on the image. The present invention includes a program which makes the controlling device control such that the determining device performs the determination, based on the image, and a recording medium in which the program is stored.

According to the present invention which adopts the above-mentioned solution device, it becomes possible to recognize the location of the tip of the manipulating implement having the tip which is finer than the optical resolving power, in the horizontal direction and in the height direction exactly, in addition to prevent the tip from contacting to be broken.

By controlling the relative position to the manipulated object point of the manipulated object which is recognized similarly, it becomes possible to perform an operation such as injection of substance with low invasion and efficiently. It should be noted that the method of controlling these operation can be performed either manually or automatically.

Furthermore, when the container which holds an manipulated object is equipped with a reflective plane intersecting the bottom surface of the container with an inclined angle of 45°, the photographing device observes the manipulating implement and the manipulated object from only one direction which is perpendicular to the bottom surface of the container, thereby it becomes possible to observe in the other direction in the reflected image within the reflective plane. Therefore, it is possible to perform observation in two directions using the photographing device of single optical system to recognize spatial relationship between the manipulating implement tip and the manipulated object in the horizontal direction and in the height direction, and hence it becomes possible to apply the constitution of conventional upright type or inverted type optical microscope. Moreover, it becomes possible to use the above constitution in combination with a photographing device, which has the recognizing device in the height direction depending thereon, and which photographs in the direction intersecting perpendicularly the bottom surface by one optical system, that is, a conventional upright type or inverted type microscope. It should be noted that only the compression stress in the direction of the axis acts slightly to the tip of the manipulating implement, and hence the tip is not broken. Moreover, detection of modification is automatically recognized by image processing, in addition, the modification can be visualized to be recognized visually.

Moreover, in the case in which it is constituted such that a granular simulated living organism sample which is softer than a living organism sample and of which size is known is dispersed to the container together with a living organism and held there, making the image processing device process the image to recognize the coordinates of the point which is specified from the shape in the image, thereby detecting the minute deformation in the pseudo living organism to correct the calculation error of the location of the tip of the manipulating implement and the manufacturing error of the manipulating implement, thereby it becomes possible to recognize the strict spatial relationship between the tip of the manipulating implement and the bottom surface of the container through the simulated living organism sample of which size and shape are known.

Therefore, the spatial relationship in the height direction with the living organism sample can also be predicted, and in addition, it becomes possible to avoid breaking due to bumping to the bottom surface of the manipulating implement even when the size and shape of the living organism sample are uneven. Moreover, it becomes possible to use the above constitution in combination with a photographing device, which has the recognizing device in the height direction depending thereon, and which photographs in the direction intersecting perpendicularly the bottom surface by one optical system, that is, a conventional upright type or inverted type microscope.

It should be noted that only the compression stress in the direction of the axis acts slightly to the tip of the manipulating implement, by the quality of material of the pseudo living organism, this stress is suppressed further compared with the contact with a living organism sample, and hence the tip is not broken. Moreover, detection of modification is automatically recognized by image processing, in addition, the modification can be visualized to be recognized visually.

In addition, in the case in which it is constituted such that the controlling part virtually recognizes a plane which includes the bottom surface of the container and the upper end of an arbitrary living organism sample, based on the spatial relationship in the height direction between the tip of the manipulating implement and the bottom surface of the container or the upper end of the living organism sample at the plurality of points in the container, it is possible to virtually determine the spatial relationship between the tip of the manipulating implement and an arbitrary living organism sample for the whole inside of the container based on the recognition at a representative points.

Therefore, working of recognizing individually becomes unnecessary, in addition, useless operation in the height direction to a plurality of living organism samples can be omitted, thereby it becomes possible to perform positioning efficiently. Moreover, it becomes possible to make the determination concerning an arbitrary living organism sample more exact by performing the recognition of spatial relationship at four or more points to choose a plurality of combinations of three points among them, and adapting an average of the plane which is defined by each.

Additional Remarks

(1) A manipulator apparatus equipped with a manipulating implement which manipulates a manipulated object, and a holding part holding the manipulating implement, including:
an image capturing device for capturing relative position information which shows the tip position of the manipulating implement to the holding part, and a tip position determining device to read an image including the relative position information to obtain the tip position of the manipulating implement.

According to the manipulator apparatus as set forth in (1), it can obtain the tip position of the manipulating implement exactly as a relative position on the basis of the holding part because the tip position determining device reads relative position information.

Thus, since it obtains the tip position of the manipulating implement as a relative position on the basis of the holding part based on relative position information, even if it is such a detailed manipulating implement that it is not reflected even if it photographs, it can obtain the tip position exactly. Since it is not necessary to contact the tip of the manipulating implement in the container like before, there is also no possibility of breaking the tip of a manipulating implement.

Moreover, since it can obtain the tip position of the manipulating implement exactly, a three-dimensional position information between the manipulating implement and the manipulated object can also be obtained exactly. It becomes possible by making this position information reflect in controlling of the manipulator apparatus to manipulate the manipulated object in which invasion is suppressed with high efficiency.

(2) A manipulator apparatus as set forth in the (1), in which the relative position information is the shape of the holding part, and tip position determining device obtains the tip position of the manipulating implement as a relative position on the basis of the form of the holding part.

According to the manipulator apparatus given in the above (2), the tip position determining device makes a coordinates standard shape (characteristic shape, such as an outline, a projection, and a ridgeline) of the photographed holding part, and it obtains the tip position of the manipulating implement in an image as a relative position to the coordinates standard.

Therefore, since the shape of the holding part which serves as a known in designing, manufacturing, or inspecting stage is used as a coordinates standard according to the manipulator apparatus given in the above (2), it becomes possible to obtain the tip position of the manipulating implement more exactly.

(3) A manipulator apparatus as set forth in the above (2), in which the holding part is equipped with a plurality of straight line parts of which extended line intersects in the tip position of the manipulating implement, and these straight line parts are formed in the position in which viewing is possible by each case where the holding part is looked at from at least 2 directions.

According to the manipulator apparatus given in the above (3), it can obtain the tip position of the manipulating implement because the tip position determining device obtains the crossing by the extension of each straight line part in the read image top. It is possible to obtain the tip position of the holding part in three dimensions by performing this on the image which is looked at the holding part from at least 2 directions, respectively.

That is, it becomes possible to obtain the tip position of the manipulating implement more certainly and exactly, based on a plurality of straight line parts of which extended line intersects at the tip position of the manipulating implement.

(4) A manipulator apparatus as set forth in the above (2), in which, in each case of looking at the holding part from at least two directions, the holding part has a shape which is equipped with a line or a plane of which relative position to the tip position of the manipulating implement is predetermined, and a plurality of arbitrary points included within these lines or planes are at equal distance from the point where the image is photographed.

According to the manipulator apparatus given in the above (4), the tip position determining device makes the line or the plane which is included in the holding part a coordinates standard on the read image, thereby it is possible to obtain the tip position of the manipulating implement as a relative position to this coordinates standard. It is possible to obtain the tip position of the holding part in three dimensions by performing the above working on each image which is looked at the holding part from at least two directions. The above line or plane used as a coordinates standard has a plurality of arbitrary points included in this in the equal distance from the point where the image is photographed. Thereby, even if the manipulating implement is arranged at the state where it is inclined such that a focal position changes in the depth direction when it is looked at from the point where the image is photographed, it is possible to photograph the image of the line or plane in one sheet in the state where the focal point is matched. Therefore, since it is not necessary to photograph a plurality of images in which the focal point is changed in the depth direction, it becomes possible to obtain the tip position of the manipulating implement by a simple operation.

(5) A manipulator apparatus as set forth in any one of the above (1) to (4), further including a container which has the transparent bottom wall surface in which the manipulated object is loaded, and a mirror surface which reflects towards just under the image which is looked at in a space on the bottom wall surface from the side.

According to the manipulator apparatus given in the above (5), the first picture can be photographed through the bottom wall surface from a just under the bottom wall surface position, and photographing the holding part. Then, the second picture which is reflected in the mirror surface and which is looked at from side the inside of the container can be photographed by photographing the mirror surface from a just under the mirror surface position. Thus, the image looked from two different directions can be photographed when looked at from the same direction.

Therefore, it becomes possible not to dispose a plurality of photographing devices of which photographing direction differs by capturing the image which photographed the holding part directly not through the mirror surface, and the image which photographed the holding part through the mirror surface. Moreover, it becomes possible to use a conventional microscope.

(6) A manipulator apparatus as set forth in the above (5), in which the bottom wall surface is arranged such that the height position of the bottom wall surface becomes higher than the lowest end position of the mirror surface.

According to the manipulator apparatus mentioned in the above (6), by arranging the bottom wall surface such that the height position of the bottom wall surface becomes higher than the lowest end position of the mirror surface, it becomes possible to photograph the image vividly, including the bottom wall surface of the container and the bottom position of the manipulated object in this picture, in the case in which the image which is looked in the container through the mirror surface from the side is photographed.

(7) A manipulator apparatus as set forth in any one of the above (1) to (6), further including a photographing device for photographing the manipulated object, and a distinction device for distinguishing at least one of the change of the shape and the position of the manipulated object, based on the image photographed by the photographing device.

According to the manipulator apparatus given in the above (7), while making the manipulating implement approach gradually to the manipulated object together with the holding part, the manipulated object is photographed, and the distinction device confirms on the image whether at least one of the shape and the position thereof changes. When it is confirmed that the change arose by the distinction device, it can obtain the tip position of the manipulating implement under the condition that the tip of the manipulating implement comes into contact with the upper end position of the manipulated object. It can be certainly confirmed whether the presumed result of the tip position determining device is right by comparing this with the tip position of the manipulating implement for which the tip position determining device obtained.

(8) A manipulator apparatus as set forth in the above (7), in which the distinction device distinguishes at least one of the center-of-gravity position change of the manipulated object or dimensions change formed by the outer shape of the manipulated object.

According to the manipulator apparatus mentioned in the above (8), external force acts on the manipulated object by applying the tip of the manipulating implement to the upper end of the manipulated object, and at least one of the center-of-gravity position of the manipulated object and the dimensions of the manipulated object changes. Then, it can obtain the tip position of the manipulating implement upon coming into contact with the manipulated object more certainly because the distinction device catches this change. Further, since this detecting work is suitable for automation, when advancing automation of control of the manipulator apparatus, it is preferred.

(9) A manipulator apparatus as set forth in the above (7) or (8), in which the distinction device divides diagrammatically such that the image of the manipulated object may be divided into a plurality of isolated areas containing the outline of the manipulated object, and judging area change of the area.

According to the manipulator apparatus mentioned in the above (9), when the tip position of the manipulating implement will be obtained by applying the tip of the manipulating implement to the manipulated object, it is preferred to divide the image of the manipulated object diagrammatically, to divide it into a plurality of areas like the present invention, and to distinguish area change of at least one area only by the center-of-gravity position change of the manipulated object and dimensions change, when distinction is difficult. That is, external force acts on the manipulated object by applying the tip of the manipulating implement to the upper end of the manipulated object, and the dimensions of one of areas changes. Then, only by the center-of-gravity position change of the manipulated object and dimensions change, when distinction is difficult, it can obtain the tip position of the manipulating implement when this comes into contact with the manipulated object still more certainly, because the distinction device catches this dimension change.

(10) A manipulator apparatus as set forth in any one of the above (7) to (9), in which the distinction device sets up arbitrary points to the image of the manipulated object and judges the change of the distance from the point to each point on the ridgeline which forms the outer shape of the manipulated object.

According to the manipulator apparatus mentioned in the above (10), in the case in which it is difficult to distinguish the center-of-gravity position change of the manipulated object, dimensions change, and the dimensions change for the edge when it intends to obtain the tip position of the manipulating implement, it is preferred like the present invention to catch the outer shape change of the manipulated object, by abutting the tip of the manipulating implement to the manipulated object. That is, by making the tip position of the manipulating implement abut to the upper end of the manipulated object, external force acts on the manipulated object, thereby changing the distance from the arbitrary point to each point on the ridgeline of the manipulated object. Therefore, by making the manipulated object approach to the manipulated object to catch the timing when the distance changes, while supervising always change of the distance with the distinction device, it becomes possible to obtain the tip position of the manipulating implement when this abutting to the manipulated object still more certainly.

(11) A process for detecting a tip position of a manipulating implement of a manipulator apparatus including:
photographing the holding part in the state of holding the manipulating implement to obtain an image of the holding part, and,
detecting the tip position of the manipulating implement, based on the image of the holding part.

According to the process for detecting a tip position of a manipulating implement of a manipulator apparatus mentioned in the above (11), it can obtain the tip position of the manipulating implement exactly as a relative position on the basis of the holding part by performing a photographing process and a detecting process.

Therefore, since it obtains the tip position of the manipulating implement as a relative position on the basis of the holding part, even if it is such a detailed manipulating implement that it is not reflected even if it photographs, it can obtain the tip position exactly. Since it is not necessary to contact the tip of the manipulating implement to the container like the above, there is also no possibility of making the tip of a manipulating implement breaking.

Moreover, since it can obtain the tip position of the manipulating implement exactly, a three-dimensional position information between the manipulating implement and the manipulated object can also be obtained exactly. It becomes possible by making this position information reflect in the device control of the manipulator apparatus to operate the manipulated object of which invasion is suppressed, at high efficiency.

(12) A process for detecting a tip position of a manipulating implement of a manipulator apparatus as set forth in the above (11), in which in the detecting step, the tip position of the manipulating implement is obtained as a relative position based on the shape of the holding part.

According to the process for detecting a tip position of a manipulating implement of a manipulator apparatus mentioned in the above (11), shape (characteristic shape, such as an outer shape, a projection, and a ridgeline) of the photographed holding part is made into a coordinates standard, and it obtains the tip position of the manipulating implement in an image as a relative position to the coordinates standard.

Therefore, since the shape of the holding part which never change is used as the coordinates standard, it becomes possible to obtain the tip position of the manipulating implement more exactly.

(13) A process for detecting a tip position of a manipulating implement of a manipulator apparatus as set forth in the above (11) or (12), further including:
the first approach step to make the manipulating implement approach to the manipulated object,
the first distinction step to distinguishes at least one of shape change, position change, and dimensions change of the manipulated object.

According to the process for detecting a tip position of a manipulating implement of a manipulator apparatus mentioned in the above (12), while making the manipulating implement approach gradually to the manipulated object together with the holding part, the manipulated object is photographed, and it is confirmed on the image whether at least of the shape or the position changes. When at least one of shape change of the manipulated object, position change, and dimensions change is confirmed in the first distinction step, it can obtain the tip position of the manipulating implement under the condition that the tip of the manipulating implement comes into contact with the upper end position of the manipulated object. It can be certainly confirmed whether the presumed result of the detection process is correct by comparing this with the tip position of the manipulating implement which is obtained at the detection step.

(14) A process for detecting a tip position of a manipulating implement of a manipulator apparatus as set forth in the above (13), in which
the first approach step and the first distinction step are performed to each at least three or more of the manipulated objects to form a virtual plane including three in each point of contact between the manipulating implement and these manipulated objects, and obtaining the relative spatial relationship between the virtual plane and the tip position of the manipulating implement about the height direction.

According to the process for detecting a tip position of a manipulating implement of a manipulator apparatus mentioned in the above (14), although the plane on which each manipulated objects loaded is inclined for example, it can respond thereto. That is, when the plane on which each manipulated objects is loaded is inclined, even if the relative position between the manipulated object and the manipulating implement as to one manipulated object only is obtained, the same spatial relationship in the height direction between each of the other manipulated objects and the manipulating implement may not be materialized. Then, by making the manipulating implement be in contact with each of three or more of manipulated objects, while considering the inclination in the above by contacting a manipulating implement to three or more operated things, it becomes possible to obtain the virtual plane which shows the height position coordinate of each manipulated objects upper end. The virtual plane can be used as a standard at the time of obtaining the tip position of the manipulating implement.

Therefore, since the virtual plane can be used as the standard at the time of obtaining the tip position of the manipulating implement, even if the plane on which each manipulated object is loaded is inclined, it becomes possible to obtain the relative position between each manipulated object and the tip position of the manipulating implement exactly, with considering the inclination.

(15) A process for detecting a tip position of a manipulating implement of a manipulator apparatus as set forth in the above (14), further including: forming the plurality of virtual planes to obtain a virtual average plane which has average inclination of the virtual planes, and obtaining a relative spatial relationship between the virtual average plane and the tip position of the manipulating implement about the height direction.

According to the process for detecting a tip position of a manipulating implement of a manipulator apparatus mentioned in the above (15), it can obtain the relative position between each manipulated object and the tip position of the manipulating implement more exactly, by using the virtual average plane which is obtained based on the average of the plurality of virtual planes as a height position coordinate of each manipulated object rather than the height position coordinate of each manipulated object which is obtained by using one virtual plane only. That is, even if a certain amount of unevenness is in the shape and size of each manipulated object, it becomes possible to equalize and absorb this unevenness.

(16) A process for detecting a tip position of a manipulating implement of a manipulator apparatus as set forth in any one of the above (11) to (15), further including:
the second approach step to dispose a simulated manipulated object of which shape and size are known in a container in which the manipulated object is arranged, and to make the manipulating implement approach to the simulated manipulated object, and
the second distinction step to distinguish at least one of shape change, position change, and dimensions change of the simulated manipulated object.

According to the process for detecting a tip position of a manipulating implement of a manipulator apparatus mentioned in the above (16), while making the manipulating implement approach gradually to the simulated manipulated object together with the holding part, the simulated manipulated object is photographed, and it is confirmed regarding an image whether at least one of the shape change, position change, and dimensions change arises. When it is confirmed that change arose in the second distinction step in at least one of shape change, position change, and dimensions change of the manipulated object, it can obtain the tip position of the manipulating implement under the condition that the tip of the manipulating implement is in contact with the upper end position of the simulated manipulated object. It can be certainly confirmed whether the presumed result of the detection step is correct by comparing this with the tip position of the manipulating implement which is obtained at the detection step.

As mentioned above, although the desirable embodiments of the present invention were explained, the present invention is not limited to these embodiments. It is the range which does not deviate from the meaning of the present invention, and addition of composition, an abbreviation, substitution, and other change are possible. The present invention is not limited by the explanation mentioned above and is limited by only the range of an attached claim.

1. Manipulator apparatus comprising:
a manipulating device for manipulating a manipulated object,
a holding device for holding the manipulating device having a size which can be detected by photography,
a picture acquiring device for acquiring an image including the holding device, and
a presuming device for presuming a position of the tip of the manipulating device, based on the image.

2. A manipulator apparatus as set forth in claim 1, wherein
the manipulating device has a size smaller than a photography resolution limit.

3. A manipulator apparatus as set forth in claim 1, wherein
the picture acquiring device has a photographing device for photographing the image.

4. A manipulator apparatus as set forth in claim 1, wherein
the presuming device presumes the position of the tip end of the manipulating device, based on an image information of the holding device which is recognized from the image.

5. A manipulator apparatus as set forth in claim 1, wherein
the image further includes the manipulated object.

6. A manipulator apparatus as set forth in claim 1, wherein
the presuming device sets the point which serves as a standard for image processing onto a predetermined position where the manipulated object recognized from the image exists.

7. A manipulator apparatus as set forth in claim 6, further comprising a spatial relationship presuming device for determining the relative spatial relationship between the position of the tip of the manipulating device and the point.

8. A manipulator apparatus as set forth in claim 6, wherein the presuming device judges contact of the tip of the manipulating device and the manipulated object, based on movement of the predetermined quantity of the point.

9. A manipulator apparatus as set forth in claim 1, wherein
the presuming device judges the contact of the tip of the manipulating device and the manipulated object based on change of an image information of the manipulated object which is recognized from the image.

10. A manipulator apparatus as set forth in claim 1, wherein the presuming device divides the manipulated object on the image into a plurality of areas, and judges the contact of the tip of the manipulating device and the manipulated object based on change of an image information of at least one of the plurality of areas.

11. A manipulator apparatus as set forth in claim 1, further comprising an information generating device which generates information for displaying location information regarding a location of the tip of the presumed manipulating device.

12. A manipulator apparatus as set forth in claim 1, wherein the manipulated object includes a living organism.

13. A manipulator apparatus as set forth in claim 1, wherein the manipulated object further includes a simulated living organism sample of which the size is known.

14. A manipulating system comprising the manipulator apparatus as set forth in claim 1.

15. An image processing apparatus used for an apparatus comprising a manipulating device a for manipulating a manipulated object, a holding device for holding the manipulating device having a size which can be detected by photography, a picture acquiring device for acquiring an image including the holding device, wherein a location of a tip of the manipulating device is presumed based on the image.

16. An image processing apparatus as set forth in claim 15, wherein
the manipulating device has a size smaller than a photography resolution limit.

17. An image processing apparatus as set forth in claim 15, wherein
the presuming device presumes the position of the tip end of the manipulating device, based on an image information of the holding device which is recognized from the image.

18. An image processing apparatus as set forth in claim 15, wherein
the image further includes the manipulated object, and
the presuming device sets the point which serves as a standard for image processing onto a predetermined position where the manipulated object recognized from the image exists.

19. An image processing apparatus as set forth in claim 18, wherein
a contact of the tip of the manipulating device and the manipulated object is presumed based on movement of the predetermined quantity of the point.

20. An image processing apparatus as set forth in claim 15, wherein
the contact of the tip of the manipulating device and the manipulated object is judged based on change of an image information of the manipulated object which is recognized from the image.

21. An image processing apparatus as set forth in claim 20, wherein
the manipulated object on the image is divided into a plurality of areas, and the contact of the tip of the manipulating device and the manipulated object is judged based on change of an image information of at least one of the plurality of areas.

22. A program for the use of a control device for controlling an apparatus, comprising: a manipulating device for manipulating a manipulated object; a holding device for holding the manipulating device having a size which can be detected by photography; a picture acquiring device for acquiring an image including the holding device; and a presuming device for presuming a position of the tip of the manipulating device, based on the image, wherein
the control device is made to control such that the presuming device performs the presuming based on the image.

23. A program as set forth in claim 22, wherein the manipulating device has a size smaller than a photography resolution limit.

24. A process for controlling an apparatus which is equipped with a manipulating device for manipulating a manipulated object, and a holding device for holding the manipulating device having a size which can be detected by photography, comprising:
photographing an image including the holding device, and
presuming a location of the tip of the manipulating device based on the image acquired by the photographing.

25. A process for controlling an apparatus as set forth in claim 24, further comprising determining the location of the tip of the manipulating device based on the image information of the holding device recognized from the image.

26. A process for controlling an apparatus as set forth in claim 24, wherein the image further comprising the manipulated object.

27. A process for controlling an apparatus as set forth in claim 25, further comprising setting a point which will be a standard for image processing at a predetermined position of the manipulated object which is recognized from the image.

28. A process for controlling an apparatus as set forth in claim 27, further comprising presuming a relative spatial relationship between the position of the tip of the manipulating device and the point.

29. A process for controlling an apparatus as set forth in claim 27, further comprising judging a contact of the tip of the manipulating device and the manipulated object, based on the movement of the predetermined quantity of the point.

30. A process for controlling an apparatus as set forth in claim 24, further comprising judging the contact of the tip of the manipulating device and the manipulated object, based on change of an image information of the manipulated object.

31. A process for controlling an apparatus as set forth in claim 27, further comprising dividing the manipulated object on the image into a plurality of areas, and judging the contact of the tip of the manipulating device and the manipulated object, based on change of an image information of at least one of the plurality of areas.

32. A process for controlling an apparatus as set forth in claim 24, further comprising generating an information for displaying locative information regarding a location of the tip of the presumed manipulating device.

33. A process for controlling an apparatus as set forth in claim 24, wherein the manipulated object includes a living organism.

34. A process for controlling an apparatus as set forth in claim 24, wherein the manipulated object includes a simulated living organism sample of which the size is known.

35. A process for controlling an apparatus as set forth in claim 24, further comprising:
defining space coordinates as at least three places in which the manipulated object exists based on a plurality of images, and
defining further a plane which passes through each of the defined coordinates to obtain a relative spatial relationship between the plane and the location of the tip of the manipulating device.
